(19) United States
(12) Patent Application Publication
(10) Pub. No.: US 2006/0156284 A1
(43) Pub. Date: Jul. 13, 2006

(54) Architecture of Ticc-Ppde, a new paradigm for parallel programming

(75) Inventor: Chitoor V. Srinivasan, Port Saint Lucie, FL (US)

Correspondence Address: Chitoor V. Srinivasan, 2031 SE Kilmallie court, Port Saint Lucie, FL, 34952, US

(73) Assignee: EDSS., Inc., Port Saint Lucie, FL (US)

(21) Appl. No.: 11/320,455

(22) Filed: Dec. 28, 2005

Related U.S. Application Data
(63) Continuation-in-part of application No. 10/265,575, filed on Oct. 7, 2002.
(60) Provisional application No. 60/576,152, filed on Sep. 6, 2005.

(51) Int. Cl. G06F 9/44

(52) U.S. Cl. 717/119

(57) ABSTRACT

Ticc (Technology for Integrated Computation and Communication) provides a high-speed message-passing interface for parallel processes. A patent for this has been already applied for (Patent Application Number 102,655/75, Dated Oct. 7, 2003). Ticc does high-speed asynchronous message passing with latencies in the nanoseconds scale in shared memory multiprocessors and latencies in microseconds scale in distributed shared memory supercomputers. Ticc-Ppde (Ticc based Parallel Program Development and Execution Environment) coupled with Ticc-Gui (Graphical User Interface) provides a component based parallel program development environment, and provides infrastructure for dynamic debugging and updating of Ticc-based parallel programs, self-monitoring, self-diagnosis and self-repair. Ticc based parallel programs may be arbitrarily scaled to run in any number of processors without loss of efficiency. Their structure, innovations underlying their principles of operation, details on developing parallel programs using Ticc-Ppde and preliminary results that support the claims are presented in this application.

### CROSS REFERENCE TO RELATED APPLICATIONS

1. This is the non-provisional of the provisional application, entitled “TICC-PP: A Ticc-based Parallel Programming System”, Application No. 60/576,152 filed on Sep. 06, 2005;

Confirmation Number 6935, dated Sep. 15, 2005.

2. This is being filed as continuation-In-part of patent application Ser. No. 10/265/575, Examiner Mr. Lewis Bullock, Art Unit 2195. patent application Ser. No. 10/265,575 was filed on Oct. 7, 2002. Its was entitled, “TICC: Technology for Integrated Computation and Communication,” and was published by USPTO on Mar. 04, 2004, Publn. Number US-2004-OO44794-A1.

3. Foreign Filing License Granted, Aug. 04, 2004, under Title 35, United States Code, Section 184; & Title 37, Code of Federal Regulations 5.15.

### BACKGROUND OF INVENTION

Ticc-Ppde is a Parallel Program Development and Execution platform that is based on Ticc. Ticc provides a high-speed message-passing interface with nanosecond latencies. A utility patent application was filed for Ticc on Oct. 7, 2002 (see 0003 below). Parallel programs developed and executed in Ticc-Ppde fully exploit the claimed properties of Ticc, and in addition provides some new capabilities, a Graphical User Interface that simplifies development and maintenance of parallel programs. Inventions in Ticc-Ppde relate generally to the following: (i) Introducing a new model of parallel process execution, (ii) Introducing new programming abstractions that simplify writing of parallel programs, (ii) memory organization that improve efficiency of execution by minimizing memory blocking, (iii) infrastructure for writing and executing arbitrarily scalable parallel programs that may be executed without loss of efficiency, (iv) component-based parallel program development methodology (v) a Graphical User Interface (GUI) for developing parallel programming networks, and for dynamic debugging and updating of parallel programs, (vi) specific implementations of Ticc security and privilege enforcement facilities, (vii) infrastructure for self-monitoring, self-diagnosis and self-repair based on principles introduced in Ticc. Items (i) through (v) above constitute the essential ingredients provided by Ticc-Ppde that make it possible to use Ticc in parallel programming environments.

Development and testing of Ticc-Ppde was supported by NSF SBIR grant, DMI-0349414 during January 2004 through December 2005. A provisional patent application for Ticc-Ppde was filed on Sept. 06, 2005, Provisional Patent Application No. 60/576,152.

[1]: Utility patent application Ser. No. 10/265,575 by Chitoor V. Srinivasan, Published by USPTO on Mar. 04, 2004, publication number UA-2004-0044794-A1, entitled “TICC: Technology for Integrated Computation and Communication.” patent application filed on Oct. 07, 2002.

### DRAWINGS

FIG. 1: A Ticc Cell.

FIG. 2: Two models of Parallel Processes.

FIG. 3: A simple pathway.

FIG. 4: A Compound Pathway.

FIG. 5: Model of Parallel Computations.

FIG. 6: Illustrating Probe Attachment Schemes

FIG. 7: In Situ Testing arrangements.

FIG. 8: Latency Test Network

FIG. 9. Non-Scalable FFT Network

FIG. 10. Scalable FFT Network

### TABLES

Table I: A generic pollPorts( )

Table II: Latency Comparisons

Table III: pollPorts( ) for Latency Test

Table IV: pollPorts( ) for non-Scalable Version of FFT

Table V: pollPorts( ) for Scalable Version of FFT

Table VI: Timing Statistics for FFT

### SUMMARY

### 1. MOTIVATION

There have been several discussions of different paradigms for parallel programming, based on languages and libraries used [14, 40], based on different message passing interfaces [15,16,17,18,19], based on data flow models [20,22], based on different hardware architectures [21,23], and based on network models [23,24]. All of these accept the inevitability of two fundamental incompatibilities: (i) Incompatibility between communication and computation speeds; this is usually compensated for by increasing grain size¹ of computations, and (ii) Incompatibility between speed of data access from memories and CPU speeds; this is usually compensated for by using cache memories, pipe-lined instruction execution and look ahead instruction scheduling.
¹Grain size as the average amount of time spent on computations between successive message passing events in a parallel processing system.

These approaches, however, do not facilitate arbitrary scaling at high efficiencies. To write, debug and run parallel programs with large scaling factors and high efficiencies, and to maintain and modify them easily we need new methodologies.

Parallel programs are costly to develop and maintain, requiring special expertise not commonly available. Parallel programming community has learnt to live with this reality. One seeks higher productivity [12,13] by increasing peak flops/sec yields of parallel processors, while maintaining compatibility to run existing parallel programs. Commodity based massively parallel duster computing will find its limits in realizable flops/sec efficiency (which is currently about 30%), realizable flopstunit-of-power efficiency and flops/unit-of-space efficiency measures. These efficiencies are likely to decrease dramatically at scaling factors of 10⁴ or 10^{6.2}
²It is claimed, Blue Gene has been scaled up to 10⁵ processors. Papers indicate 30% efficiency with 9000 processors. It is not clear whether applications using all the 10⁵ processors have been written and tested. Our objective here is to write and run parallel programs at near 100% efficiency, independent of the scalng factor.

With nano-scale computing [33] fast approaching (in the coming decade) and quantum computing (in the next two decades), we may confront a need to perform massively parallel computations at 10⁴ and 10⁶ scales. To do that we will need (i) new models of parallel computations, and new methods to (ii) develop parallel programs, (iii) debug and maintain them, (iv) run them efficiently with very small grain sizes, (v) manage message passing with nanosecond latencies, and (vi) organize memories and CPUs. The paradigm introduced here will provide means to address these issues. Even without pressing need to scale by factors of 10⁴or more, the new paradigm has immediate benefits to offer It can easily double the performance of any existing shared-memory supercomputer³, at low grain sizes of the order of 50 to 100 microseconds with scaling with in limits of hardware technology.
³We use the terms shared-memory “supercomputer” and “multiprocessor” interchangeably. In this paper, these terms always refer to shared-memory multiprocessors or tightly coupled distributed-memory supercomputers, where each memory unit is shared by a group of processors in a neighborhood and adjacent neighborhood groups may write in each others memory.

Ten Requirements: We posit the following as being essential to fully realize large scale, easily manageable parallel computations in any technology: (i) very low communication latencies, (ii) efficient running of parallel programs with message-flow driven self-synchronized scheduling, (iii) automatic asynchronous execution and coordination, (iv) processes using only local data and data received through message passing, (v) computations supported by local memories, shared with processes in given neighborhoods, (vi) messages communicated using only local memories, (vii) methods for dynamically debugging parallel programs, and infrastructures for deploying (viii) security and protection, (ix) dynamic modifications and updating, and (x) self monitoring and self repair.

Scalable parallel processing hardware networks appear in cellular automata [25,261, systolic machines [20], and asynchronous data-flow machines [22]. We present here a new paradigm for developing and running scalable parallel software systems, which have the potential to satisfy all the above characteristics.

We have built prototypes of Ticc⁴ (new Technology for Integrated Computation and Communication), and Ticc-Ppde⁵ (Ticc-based Parallel Program Development and Execution Environment) with Ticc-Gui (Graphical User Interface). At present, the prototype Ticc-Ppde can be used only in shared-memory environments. Test results are shown in (Section 8).
⁴Patent Pending. Patent application Ser. No. 102,655/75, dated Oct. 7 2002, Published Mar. 04, 2004, US-2004-00447

⁵Patent Pending, Provisional Patent Application 60/576,152, Dated Sep. 06, 2005. Subject of this patent application.

Message passing latencies were of the order of 350 nanoseconds to 3.5 microseconds for messages of length 0 through 1000 bytes. We built two versions of complex double precision one-dimensional FFT (Fast Fourier Transform) [36], one not scalable and the other potentially scalable. Both ran at 100% to 200% relative efficiencies⁶ at grain sizes of 50 to 100 microseconds (Section 8.2) [29,30].
⁶Two hundred percent relative efficiency is obtained here because of cache memory limitations. Cache could not hold all needed data in sequential computation with one processor. Since data were split among several processors in parallel computation, each processor could hold all data it needed in its cache.

In the following, we introduce the two fundamental concepts that gave rise to this new paradigm: (i) a new model of parallel processes and (ii) integrated computations and communications. We show how abstractions introduced by the new model simplify parallel program development and, together with integrated computation and communication, provide a rich collection of benefits which have the potential to satisfy all the ten requirements mentioned above.

1.1 Overview of Disclosure

We begin Section 2 below with a brief description of top-level structure of Ticc. This sets the basis for describing in Section 3 the two innovations that gave rise to Ticc-Ppde, consequent properties, benefits they confer and some operational details. We then present in Section 4 (first section of detailed description) a brief historical background and point out bottlenecks we have inherited. Elements of Ticc are introduced in Section 5. We begin by comparing Ticc with MPI [15], CSP [34] and π-Calculus [42, 43, 44, 45] and then describe the structure and operation of Ticc. Parts of this Section were presented already in our patent application on Ticc [28c]. They are presented again here for convenience. Paragraphs that review features of Ticc are marked “(Ticc)” and paragraphs that define or comment on features of Ticc-Ppde are marked “(Ticc-Ppde)”. Section 6 introduces Ticc models of sequential and parallel computations [28c] and points out the change in the Ticc models that Ticc-Ppde introduced in order to simplify parallel programming. Section 7 gives a brief overview of the structure of implementation of Ticc and Ticc-Ppde. Section 8 summarizes three Ticc-Ppde parallel programs and presents test results. This is followed in section 9 by concluding remarks. Ticc and Ticc-Ppde are closely intertwined, each adding to the other to create this new parallel programming and execution environment.

The tests provide a proof of concept demonstration of the new paradigm that shows concepts in the new paradigm are sound practical and can be generalized to distributed shared memory supercomputers.

### 2. TOP LEVEL STRUCTURE OF TICC-PPDE

Ticc and Ticc-Ppde are both written in C++ and run with LINUX operating system. Ticc-Ppde provides an API (Application Programmer Interface) to develop and run parallel programs in LINUX C++ development environment. Ticc-Gui may be used to set up, debug, run and update Ticc-based parallel processing networks.

2.1. Structure of Cells and Computations

(Ticc & Ticc-Ppde) Parallel computations in the new paradigm are organized around active computational units called, cells.⁷ Cells contain ports. The cell to which a port is attached is called the parent cell of the port, which is always unique. Ports of different cells in a Ticc-network will be interconnected by pathways. A port may have at most only one pathway connected to it. Cells will use their ports to exchange messages with other cells via pathways connected to them. Message might be a service request sent by one cell to another or it might be a response sent back to the cell that requested service.
⁷We use italics to mark undefined terms, terms that are defined when they are first introduced or defined later in the text.

(Ticc-Ppde) Computations performed by a cell in a Ticc-network will consist of (i) receiving service requests, performing requested services and sending back results, or (ii) preparing service requests, sending them to other cells and receiving responses. Each cell in a network will run in parallel with other cells, each in its own dedicated CPU. Cells, ports and pathways are C++ classes with their own data structures and methods defined for them. They are not hardware devices.

(Ticc) Cells have different kinds of ports. GeneralPorts are used to send service requests and receive replies. FunctionPorts are used to receive service requests and send back responses. A cell may have an arbitrary number of general and function ports. Each cell will also have a set of four designated ports: interruptPort, statePort, diagnosisPort, and csmPort. Details on use of designated ports are not important at this time, except to note that interruptPort is used by a cell to receive interrupt messages from other cells, which may start, stop, suspend and resume computations performed by the cell.

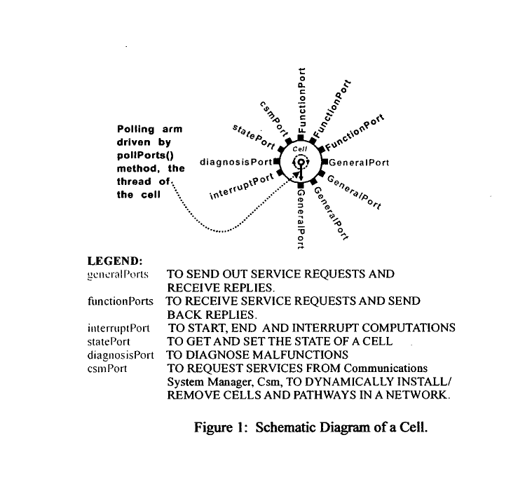

(Ticc) Active constituent of a cell that drives computations performed by the cell is its process, called pollPorts( ). The schematic diagram of a cell is shown in FIG. 1. Its pollPorts( ) method is represented in the schematic by its polling arm.

[image]

2.2. Polling and Message Driven Activation

Polling Process and Threads: (Ticc-Ppde) Once a cell is activated it will begin running its pollPorts( ) process in its assigned CPU. Each pollPorts( ) process will consist of a collection of threads, at least one for each port of the cell. Cell will use its pollPorts( ) to poll its ports in some order, in a cyclic fashion, to receive and respond to messages or to send service requests. Message received at a port will determine the thread used to respond to that message. Two threads in the same cell are said to be dependent on each other if data produced by one are used by the other. They are independent if neither use data produced by the other. Two ports of a cell are mutually independent if all threads at one port are independent of all threads at the other port. Cells in Ticc-Ppde may have mutually independent ports. Port independence is an important property introduced by Ticc-Ppde.

(Ticc-Ppde) We will use Th(P) to refer to a thread at port P, R(P, m1) to refer to the part of Th(P) that is used by port P to respond to message m1, and S(P, m2) to refer to the part of Th(P) that is used by P to send out message m2. Task performed at a functionPort, fP, will have the form⁸
⁸We use “:” to indicate definition of item to its left Definition appears to its right.

Th(fP): [R(fP, m1), S(fP, m2)], (1)
where m1 is the received message and m2 is the message sent out in reply. For every service request there will be a reply. It is possible that R( . . . ) may have some embedded S( . . . ) for service requests it might send to other cells in the middle of responding to message m1. Task performed at a generalPort, gP, will have the form
Th(gP): S(gP, C(gP)), (2a)
where C is the computation performed to construct a required service request message. S(fP, C(fP)) constructs a service request message and sends it off. When a reply message is received at gP one may have
Th(gP): R(gP), (2b)
where R(fP) may simply save a pointer to the reply locally or do any other operation depending on application. Reply will be received only after a certain delay. A cell need not wait to receive the reply. It may instead immediately proceed to service another independent port after sending the service request and return later to gP to receive the reply. This is, of course, possible only if the cell had mutually independent ports.

Message Driven Activation: (Ticc-Ppde) A cell not running its pollPorts( ) will be activated automatically by the first message delivered to it via any one of its ports. After activation, operating system cannot interfere with its computations. Only other cells in the network may influence its computations, by sending messages to the cell. Messages will be exchanged only when data needed to respond to them are ready. Ticc [28c] pointed out this possibility for message driven activation of cells, but it is Ticc-Ppde that actually implemented it and used it to run parallel programs.

(Ticc-Ppde) Activation of a cell in LINUX takes about 2.5 microseconds, more than 6 times the average latency. However, cell activation is done only once for each cell. Once activated, the cell will start running its pollPorts( ) method. Thereafter, every time a new message is sensed at a port the appropriate thread at that port will be automatically activated.

Process Scheduling: Ticc-Ppde clones certain parts of LINUX operating system that are involved in process scheduling. Ports use these clones, which are a part of Ticc-Ppde, to make the operating system do their bidding in scheduling and activating processes, and prevent the operating system from interfering with their scheduling decisions. LINUX itself is not changed in any manner.

The novel concepts in Ticc and Ticc-Ppde that makes this new paradigm work are introduced in the next section.

### 3. CONCEPTS IN THE NEW PARADIGM

3.1. New Model of Parallel Processes

[image]

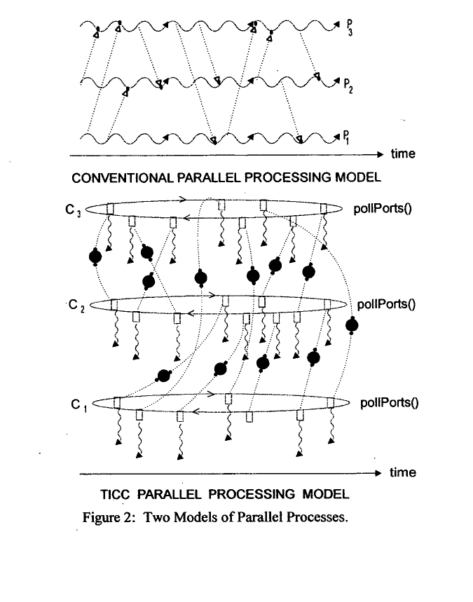

Conventional Model: A parallel process is usually viewed as a collection of sequential processes communicating with each other by sending messages. This is shown in the top diagram of FIG. 2. P₁, P₂ and P₃ are processes of an application. They are running in parallel. Control flows along each process horizontally from left to right. Arrows jumping off these processes represent messages sent by one process to another. For simplicity, we show here only point-to-point message exchange. Facilities like MPI [15] provide mechanisms for exchanging such messages. Processes of MPI that transmit and deliver messages are distinct from the processes P₁, P₂ and P₃ of the application. MPI may invoke assistance of an operating system to perform its tasks.

New Ticc Model: (Ticc-Ppde) The bottom diagram in FIG. 2 shows the model of parallel processes in the Ticc paradigm. C₁, C₂ and C₃ are cells. The ellipses represent the pollPorts( ) processes of the cells. Small rectangles on the ellipses are the ports. Pathways connect these ports. Cells exchange messages between ports using the pathways. Each pathway contains its own memory (dark disks in FIG. 2). This memory will hold the message that is delivered to a port. In the current implementation, this message is defined by a C++ Message class, with its own associated data structures and methods.

Threads: (Ticc-Ppde) Parallel processing computations are performed not by the pollPorts( ) processes in FIG. 2, but by the little threads that hang down orthogonal to the ellipses. At any time only one thread in each cell will be running. Thus in FIG. 2, three threads will be running at any time in the bottom diagram corresponding to the three processes in the top diagram. As mentioned earlier, since threads at different ports of a cell, may perform computations that are independent of each other, threads of any given cell will not together constitute a sequential computation in the conventional sense. However, the three cells together will ultimately perform the same computation that is performed by the conventional model. Ticc model of parallel computation, discussed in Section 6, explains how this is accomplished.

Before discussing the benefits conferred by the Ticc-Ppde model, it is instructive to first explore the structure of pollPorts( ) method, as it would appear in C++. In the discussion below we assume, pathway memory will have only one unique message in it. As we shall later see, models of Ticc parallel computations make this hold true. Hereafter, whenever we say a cell is performing a computation, it should be understood that one of its threads is doing that computation.

3.2. Generic PollPorts

Integration of Computation & Communication: (Ticc-Ppde) We present here fragments of code in Ticc-Ppde that illustrate the advantages of abstractions introduced in Ticc-Ppde, and a top level view of how computation and communication are integrated in Ticc-Ppde. Whereas in Ticc [28c] cells delegated message transmission to one or more dedicated communication processors, in Ticc-Ppde each cell by itself may directly and immediately transmit messages. No communication processor is necessary. In the following, we will assume familiarity with C++. One may write in C++ the function, S(P, m) used in (1), as the method, P→S(m), where P is the pointer to port P and m is the pointer to message m; P→S(m) may be decomposed to,⁹
⁹We use “:=” to indicate code decomposition.

P→S(m):=[P→W(m); P→S( );], (3)
where P→W(m) writes m into the memory of the pathway attached to P and P→S( ) sends it off to its intended recipients. P→S( ) will not invoke any assistance from any other process to transmit and deliver m. The process that transmits and delivers message will be entirely embedded in the thread Th(P) and thus will be fully executed by the thread itself. The manner in which a cell uses its CPU to send a message is no different from the manner in which in may use its CPU to do an arithmetic operation. It is in this sense computation is integrated with communication in Ticc-Ppde.

Thread at a Function Port: (Ticc-Ppde) When a cell senses receipt of a message m1 at a functionPort fP, it will automatically immediately activate the thread Th(fP) shown in (1). Th(fP) may be defined as,
Th(fP):[R(fP,m1), S(fP,m2)]:=fP→R( );fP→S( ); (4)
Here fP→R( ) has no reference to received message ml, since it will be the message in the pathway attached to fP. One may here think of R( ) as the process that responds to m1. Suppose, fP→read( )=m1 is the pointer to the message ml in fP's pathway memory. Then one may decompose fp→R( ) as,
fP→R( ):=fP→W(fP→read( )→processMsg(fP)); (5)
where processMsg( ) is the method defined in the message subclass of m1. It processes message m1 and returns a pointer m2 to the reply message m2. fP→W(m2) writes m2 into pathway memory. One may use the polymorphism feature of C++ to automatically invoke the right processMsg( ) associated with the message subclass of m1, no matter what subclass of message it is. Since fP→R( ) would have already written the reply message into the pathway memory no reference to this message is needed when it is sent out Thus we use fP→S( ) in (4).

(Ticc-Ppde) The pathway memory here will itself provide the execution environment for m1→processMsg(fP). Thus, message m1 need not be copied. If the message subclass of m2 that is returned by m1→processMsg(fP) always remains fixed then one may write a properly initialized instance of m2 into the memory of pathway at fP at the time the pathway was installed, and simply update it every time m1→processMsg(fP) is evaluated. This will simplify (5) above to,
fP→R( ):=fP→read( )→processMsg(fP)); (6)
thereby eliminating one write operation. We refer to messages installed in pathway memories in this manner as containers. In all cases, responding to a received message is mandatory in this model.

Thread at a General Port: (Ticc-Ppde) In the case of a generalPort, gP, one may have
Th(gP): [gP→C( . . . );], (7)
where gP→C( . . . ) is the computation performed at a general port, defined as
gP→C( . . . ):=[gP→W(gP→X( . . . ));gP→S( )], (8)

where gP→X( . . . ) is a method, which constructs a message and returns a pointer to it. This might be the message that defines a service request based on its arguments. This will be an application dependent

TABLE I
A generic pollPorts( )

int Cell::pollPorts( ) {

/*Initializes the cell when activated. Each cell may install more cells
in a network when it is initialized. We view them as seeds that make
a network grow. Hence the name installSeedCells. */

if (initializationFlag) {

installSeedCells( );
initializationFlag=false;

}
/*Continue polling as long as stopPolling is false.*/
while (!stopPolling) {

/*nOfGnPorts is the number of general ports.*/
for (int i=0; i < nOfGnPorts; i++) {

if (gP[i]->pathwayReady( ) ) {

gP[i]->W(gp->X(i, . . . ) );
gP[i]->S( );

}

}
for (int i=0; i < nOfGnPorts; i++) {

if (gP[i]->messageReady( ) ) gP[i[->R( );

}
/*nOfFnPorts is the number of function ports.*/
for (int i=0; i < nOfFnPorts; i++) {

if (fP[i]->messageReady( ) ) {

fP->W(fP->read( )->processMsg(fP) );
fP[i]->S( );

}

//terminates if interrupt message is present
if (interruptPort.messageReady( ) ) {

stopPolling = true;
prepareToTerminate( );

}

}
return 0;

}

method. In (8) this message is written into memory and sent off. Again, if the message class written into memory is always the same one may use containers and simplify (8) to
gP→C( ):=[gP→X( . . . ); gP→S( )], (9)
eliminating one write operation. Later, when a reply message is sensed at gP one may perform gP→R( ), which may simply locally save a pointer to the reply message or do anything else that might be appropriate for an application.

Grain Size: (Ticc-Ppde) The time spent by a thread at a port to complete its computations will be the grain size of parallel computations, which may range from 50 to 100 microseconds in the current implementation of Ticc. Sending a message will consume about 400 nanoseconds of this grain size.

Generic Codes: (Ticc-Ppde) It may be noted, fragments of code shown above are all generic. Indeed, one may write a generic pollPorts( ) as shown in Table I, using these fragments. Implementation of Ticc-Ppde uses generic pollPorts( ) like these. For different applications, the message subclasses will be different. Each application will have some variations on the generic code shown in Table I. We present Table I to illustrate simplicity of code generation in the new paradigm.

3.3. Benefits conferred

Many of the benefits enjoyed by Ticc-Ppde follow directly from this new view of parallel processes.

New Abstraction Layer: (Ticc-Ppde) When a cell sends a message via one of its ports, unlike MPI [15], it does not have to specify source, destination, length, data-type, or communicator in the send/receive statements. This information is built into the pathways. No tags or contexts are needed in Ticc since each thread is obligated to respond to a message as soon as it is sensed, and no buffers holding message queues are used (Section 6). One may simply use P→R( ) and P→S( ); message in memory of a pathway will then be responded to and sent.

(Ticc-Ppde) Pathways thus provide a level of abstraction that decouples source, destination and message characteristics from send/receive operations and local computations. This simplifies programming considerably and makes it possible to dynamically change the structure of parallel processing networks, independent of send/receive operations and computations used in them. One may add/remove cells, ports and pathways without interfering with ongoing computations (Section 7). One may even run the same parallel program on two different networks. Only the initialization methods and pollPorts( ) might be different. We will see an example of this in Section 8. This facilitates dynamic reconfiguration. Ticc pathways also play important roles in dynamic debugging, dynamic monitoring and updating of Ticc-based parallel programs, as we shall later see. (Section 7)

(Ticc-Ppde) Pathway abstraction in Ticc-Ppde is analogues to the data type abstraction in programming languages. Pathways introduce a new level of flexibility and generality to specifications of communications in parallel programs, just as data types introduced a new level of flexibility and generality to specifications of operations in conventional programs. There are several other unexpected benefits as we shall see below.

Security Enforcement: (Ticc) In Ticc, one may define for each port a security profile and use the pathway connected to the port to enforce defined security at the time of message delivery. Security enforcement at a port may even depend on the number of times message was sent or received at that port; a mode of security enforcement unique to Ticc. Agents attached to pathway memory, small green discs in FIG. 2, perform this function (Section 5.5). Ticc-Ppde implements this security enforcement facility.

Minimizing Memory Blocking: (Ticc-Ppde) In tightly coupled distributed shared memory systems by allocating pathway memories judiciously and defining message classes appropriately, one may avoid both memory blocking and memory contention (Section 6.4). This facilitates arbitrary scaling.

Send & Delivery Synchronization: (Ticc) Only control signals will travel along pathways. Signals traveling along a pathway will establish the context at which message in the pathway memory may be received and responded to by a thread at the port to which it was delivered. When a message is sent from a group of sending ports to another group of recipient ports (we will refer to these groups as port-groups), agents on pathways will be responsible for the following (Section 5.5): (a) receive, gather and forward signals traveling on pathway; (b) enforce message security and protection; (c) synchronize broadcast of message in pathway memory to all recipient ports in a port-group; (d) synchronize message dispatch by ports in the sending port-group, and (e) clock computational and communication events that occur around pathway memory;. The task (c) is called delivery synchronization and task (d) is called send synchronization (Section 5.5).

Synchronization Levels: (Ticc-Ppde) In the current implementation of Ticc-Ppde, both send and delivery synchronization has two levels of synchronization with increasing precision and cost. Message are delivered to a recipient port-group of size g in level-1 synchronization with in 2 g nanoseconds, and g nanoseconds in level-2, where g is the size of receiving port-group. In send synchronization, timings in level-1 and level-3 will be application dependent (Section 5.5).

To get good efficiencies, we believe, g should be ≦16 in the current implementation. In Ticc-Ppde, both send and delivery synchronizations are automatic. They are built in features of Ticc-Ppde with user controls only for specifying the level.

We could not find analogs to these in MPI.

Low Latency Communications: (Ticc) Agents and ports on a pathway that receive and send signals are tuned to each other to guarantee that no agent or port will ever fail to promptly receive and respond to a signal that is sent to it. Tuned ports and agents will thus be always listening to each other at right times (Section 5.2). Thus, no signal will ever be missed and no agent or port need ever wait for synchronization. This contributes to high-speed message exchange with guaranteed message delivery.

Scalability: (Ticc-Ppde) Since threads themselves execute all protocol functions necessary to cause messages to be delivered, and since each cell in a network runs in its own dedicated CPU, all messages will be exchanged in parallel. Number of messages that may be exchanged at any time will be limited only by the number of active cells at that time. Since each port may be connected to only one pathway, Ticc guarantees message delivery without message interference. These features, coupled with ability to control memory blocking, facilitate arbitrary scalability, limited only by the available hardware technology.

The structure of pathways and use of a special Causal Communication Primitive (Ccp) in programming language that make this kind of communication possible are explained in Section 5.

The engine that drives Ticc-Ppde is the Ticc communication system. In the new paradigm, Ticc takes over the role that MPI plays in conventional parallel processing. The difference is, Ticc together with Ticc-Ppde provides practically unlimited number of parallel simultaneous asynchronous buffer free message transfers, with guaranteed high-speed communications without message interference, and with automatic asynchronous message driven execution of parallel processes, all without assistance from application programmer.

3.4. Polling Modes

(Ticc-Ppde) We use a weak definition for synchronous and a strong one for asynchronous: An event in a system is synchronous if its time of occurrence has to be coordinated with the time of occurrence of another event in the same system. They need not necessarily occur at the same time. An event in a system is asynchronous if its time of occurrence does not have to be coordinated with the occurrence of any other event in the system. We will soon see why these notions of synchrony and asynchrony are unique to Ticc and are different from the way they are used in other systems, including MPI [15].

Asynchronous Receiving: (Ticc-Ppde) In asynchronous receiving, while polling a port, P, a cell will not wait for a message to arrive. It will simply check for a message at port P by evaluating, “P→messageReady( )”, and respond to it if one existed, else proceed immediately to poll its next port. This is asynchronous in the sense, the time at which this happens is not coordinated with any other event. A cell may check for a received message at any time it chooses. Clearly, threads at a port P and its next port should be independent if asynchronous receiving is used on P. The generic pollPorts( ) shown in Table I uses only asynchronous receiving. We will refer to computations performed with asynchronous message receipt as asynchronous computations.

Checking and ignoring messages, as is done in MPI, based on tag or context is different from asynchronous receiving. In Ticc, every thread is obligated to respond to a message as soon as it is sensed. No tag or context is used in Ticc-Ppde.

Synchronous Receiving: (Ticc-Ppde) In synchronous receiving, cell will use “P→receive( )” to wait at port P for a message. It will respond to the message when it arrives, and then only poll its next port. We call this synchronous because starting of the thread that responds to a received message is in this case coordinated with sending of that message by another thread. This is similar to blocking receive in MPI. There are differences though, since messages do not have to be copied in Ticc. PollPorts of FFT described in Tables IV and V of Section 8 uses synchronous receiving. We will refer to computations performed with synchronous message receipt as synchronous computations. It is always harder to write code for synchronous computations than i is for asynchronous ones. In synchronous computations, one has to be careful to avoid dead locks.

It should be noted, when synchronous receiving is used at a port, P, it is possible that computations performed at P and its next port in a cell may be dependent on each other. This happens, for example, in the FFT code shown in Tables IV and V (see Detailed Description, Section 8).

Asynchronous Sending: (Ticc-Ppde) In asynchronous sending of messages cell will use “P→pathwayReady( )” to check whether pathway at port P is ready to send a message. If it is, then it will send its message, else proceed immediately to poll its next port. This is asynchronous because the time at which a cell chooses to do this is not coordinated with of any other event. Again, threads at port P and its next port should be independent.

(Ticc-Ppde) It may be noted asynchronous receiving and sending are feasible in Ticc-Ppde only because it is possible for adjacent ports in a cell to be independent. No analogs to these exist in MPI [15] or CSP [34]. In CSP, all communications are synchronous in the sense of Ticc.

Synchronous Sending: (Ticc-Ppde) In synchronous sending, cell will use “P→sendImmediateIfReady( )” to wait for pathway at a port to become ready and then send message. It will poll its next port only after sending the message. This is synchronous because readiness of a pathway here requires coordination with another thread. In certain ways, synchronous sending in Ticc-Ppde is similar to non-blocking MPI-send where a process waits for a buffer to be cleared. Again, there are differences; Ticc has no buffers.

There is no need in Ticc-Ppde for synchronous sending in the sense of MPI, where a sender waits for its intended recipient to become ready to receive a message. This is because cells will always send messages at any time they please, if pathway is ready. Recipient need not be ready to receive the message.

Suspend/Resume mode of Polling: (Ticc-Ppde) In the middle of responding to a service request received via one of its functionPorts, fP, if a cell had to send a service request to another cell, then after sending the service request via one of its generalPorts, gP, the cell will not wait to receive a response. It will suspend its current operations at fP and proceed to poll its next independent port. It will resume the suspended operation at fP later when it polls fP again, if response to its request had been received by then by gP. Such suspend/resume operations will be done automatically without need for operating system intervention. Thus, no cell will wait at a port to receive a message, unless it was specifically designed to do so in carefully coordinated synchronous computations. Together with low latency communications, this contributes to high efficiency. Again, it may be noted, this mode of operation is feasible only if threads in a cell have mutually independent pairs.

(Ticc-Ppde) Two cells, X, Y, will be in a deadlock if they are blocking each other from proceeding further with their computation. This may happen if X is waiting for a response from Y to proceed further, and similarly Y is waiting for a response from X. Since no cell waits for response from another cell in Ticc-Ppde, except for purpose of coordinated synchronous computations, no deadlocks will occur in Ticc-Ppde.

3.5. Pathway Components

Virtual Memories: (Ticc) These are the memories associated with pathways. They could be memory areas allocated from different physical memories in a tightly coupled distributed shared memory system or an allocated memory area in a shared memory system. Allocation of virtualMemories in shared memory systems is straightforward.

(Ticc) Each virtual memory will have three components: A read-memory, R, write-memory, W, and a scratchpad memory, SP. R will contain the message to be delivered. The message in R will usually be delivered to a port-group, say G1. Parent cells of ports in the port-group will write their response messages into W. They will use SP for exchanging data among themselves while responding to the message. SP may also provide execution environments for threads used by ports in a port-group. When response message is delivered to another port-group, say G2, R and W will be switched. This will enable ports in G2 to read from their read-memory message written by ports in G1 into their write-memory.

(Ticc-Ppde) In tightly coupled distributed memory environments one has to make sure that processes would always process received messages only in their local memories (read-memories R), and write messages into local memories of recipient cells (write-memories W). To make this possible, we will assume each memory module may be shared by g CPUs (cells), where g is the maximum size of a port-group. We will also assume, each CPU could directly write into designated memory areas of a limited number of other CPUs. If a cell has at most n ports, and is running on cpu_{—}1, then it is possible that ng other CPUs might simultaneously attempt to write into the local memory of cpu_{—}1. However, this is highly unlikely. Experimentation is necessary to determine bounds that actually occur in practice.

Ticc-Ppde provides a way of interrupting parallel computations at specified parallel breakpoints. After such a break, one may examine data held in various virtual memories. This makes it possible to develop dynamic debugging facilities for parallel programs in Ticc-Ppde (Section 7.4).

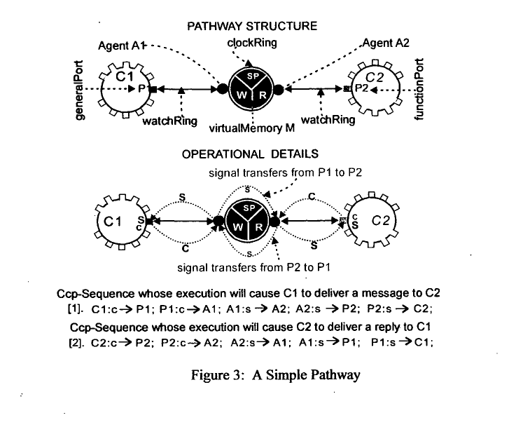

Agents: (Ticc) For each virtualMemory, M, agents of M are organized in a ring data-structure. By convention, signals flowing along the pathway of M will flow from one agent to its next agent on the ring in clockwise direction. We refer to this ring as clockRing, since agents on this ring clock computation and communication events occurring around M. In the schematic representation of a pathway, we enclose M inside the clockRing of agents that surround it (see FIG. 3).

Ports: (Ticc) We think of ports as belonging to cells, even though each port may have a pathway connected to it

3.6. Operational Details

Starting and Stopping Computations: (Ticc-Ppde) Ticc-Ppde has a distinguished cell called Configurator. It is used by Ticc-Gui to set up Ticc-network, initialize virtual memories and pathways, and start parallel computations by broadcasting a message to interruptPorts of a selected subset of cells in the network. This will activate the selected cells. From then on computations will spread asynchronously over the network in a self-synchronized manner modulated by messages exchanged among cells. When parallel computations are completed each cell in the network either may itself terminate, based on some locally defined conditions, or may terminate based on an interrupt message received via its interruptPort from another cell. As a cell terminates it may send an interrupt message to the Configurator. When Configurator had received, interrupt messages from all cells that sent them, it will terminate polling it ports, transfer control to C++main or Gui, print outputs and cause the network to be deleted, including itself.

Partitioning Resources of a Supercomputer. Ticc-Ppde could run in a shared memory supercomputer together with any other message-passing platform. Thus, one need not discard ones parallel software resources. If a supercomputer had, say N processors, then any portion of it may be assigned to running Ticc-based parallel programs, and the rest assigned to run on any other message passing platform. Ticc will have no knowledge of the processors assigned to other systems and vice versa. They will have independent resources assigned to them and could run at the same time without interference.

Developing Parallel Programs: (Ticc-Ppde) Programming a parallel processing application will consist of defining the following in C++: (i) Cell subclasses in an application, (ii) pollPorts( ) method and all other methods called by pollPorts( ) for each cell subclass, (iii) message subclasses used in the application, and (iv) Ticc-network. The only new task is setting up Ticc-network. This is easily done using Ticc-Gui.

(Ticc-Ppde) Efficiency with which a parallel application runs in Ticc-Ppde is crucially dependent on the Ticc-network set up for that application. Once the necessary initial network is set up, Ticc-Gui may be used to start computations in the network, and debug parallel programs dynamically using parallel breakpoints in a manner similar to using sequential breakpoints in ordinary sequential programs. During computations, the network may grow or shrink dynamically. One may also use Ticc-Gui to dynamically update a parallel program and monitor its performance (Section 7). These simplify parallel program development and maintenance in Ticc-Ppde.

3.7. Concluding Remarks

Ticc message passing facility and Ticc-Ppde models of parallel computation provide a framework to design and implement parallel programs using cells in Ticc-networks. It has the following features (i) pathway abstraction with built in synchronization features that simplify writing of parallel programs; (ii) self-synchronized self-scheduled message-driven asynchronous thread execution with no user participation; (iii) parallel execution control structure that is isomorphic to message flow structure in a network of cells and pathways; (iv) low latency communications, (v) capability to simultaneously transfer practically unlimited number of messages in parallel at any time without message interference, (vi) mutual independence of threads in asynchronous polling, (vii) virtualMemory allocation to minimize memory blocking, and (viii) facilities for dynamic security enforcement, debugging and updating. These features together simplify parallel program development and maintenance, yield high execution efficiencies even at low grain sizes, and scalability. With this preamble, we will now introduce the structure and operation of Ticc and Ticc-Ppde, and illustrate their use through three simple examples. A user manual for developing parallel programs using Ticc-Ppde and Ticc-Gui is now in preparation [29]. It is not pertinent to the subject matter of this patent application, because its details are incidental to the current implementation. Implementation may change in the future while preserving all the fundamental features of Ticc-Ppde, claimed in this patent application.

### 4. HISTORICAL BACKGROUND (SECTION NUMBERS CONTINUE WITH SUMMARY)

Dichotomy between Computation and Communication: We carry a historical burden. There are no integrated conceptualizations of communication and computation: Communication is not a part of program specification in our theoretical models of programming, which are based on three primitives assignments, if-then-else statements, and while statements, and conventions for program control [1,2,3,4,5,6,7]. They do not provide input/output or message/passing primitives. It is common to view communication, as a necessary evil one has to suffer in order to do computations.

Turing machines [8, 10] provide a theoretical model of sequential computations. It provides a definitive definition of what a sequential computation is. It is possible to write a universal Turing machine simulator and use it to run compiled Turing machine programs. PRAM [35] models are good for analysis of parallel programs, as also multi-tape Turing machines [7]. They do not provide a complete model of parallel computations since they ignore synchronization and coordination by assuming a single universal clock. π-calculus [42, 43, 44, 45] provides a comprehensive model of cuncurrent computations, where interactions among independent units are the basis for all computations. It is, however weak on synchronization and abstractions needed for easy programming. We will say more on this in Section 5.1.

Lack of Synchrony in Software: Reasons for this dichotomy are quite simple: For communication to occur, receivers should listen to senders at right times and fully absorb messages. This requires a certain synchrony. Such synchrony does not naturally manifest among parallel processes or among interrupt driven concurrent processes. Consequent gap is bridged by using protocols, synchronization sessions, buffers holding message queues, and by programmed punctuated data exchange sessions among parallel processes. These add to latencies.

Synchrony in Hardware: There is no such dichotomy in hardware. Communication, synchronization and coordination are all a part of every connected pair of hardware components. Clock pulses enforce synchrony in synchronous hardware circuits. Start and completion signals between connected hardware units enforce synchrony in asynchronous hardware circuits. Thus, programs rely on hardware circuits to perform communications, invoking operating system intervention within programming systems to use hardware at right times in the right manner. This requires synchronization sessions and use of buffers with message queues. Consequent software complexities that add to latency are hidden from users.

Bottlenecks: This gives rise to the first two of three bottlenecks we face in parallel programming technology: (i) Communication Bottleneck: This is caused by high communication latencies and inability to cater to communication needs of parallel processes in a timely manner. (ii) Debugging Bottleneck: Caused by lack of tools to dynamically debug parallel and concurrent processes. (iii) Memory Bottleneck: Data cannot be fetched from memory at rates adequate to feed the n all active parallel processes. This is caused by memory bandwidth limitations and memory blocking.

Ticc eliminates the first bottleneck above (Sections 5) and Ticc-Ppde eliminates the second one (Section 5). The two together can help eliminate the third bottleneck through appropriate allocation of virtual memories and organization of messages (Section 3.5).

### 5.0. MESSAGE PASSING IN TICC

5.1. Ticc, MPI, CSP, π-Calculus

MPI: Unlike MPI, Ticc is a connection oriented communication system. A message can be sent only if there is a pathway connecting senders and receivers. A cell may establish a pathway between two ports only if it had the appropriate privilege to do so. Privileges are used in Ticc-Ppde to enforce application dependent security. We have already discussed differences between MPI and Ticc. Let us now briefly consider how Ticc differs from CSP.

CSP: CSP [34] is also a connection oriented communication system. All communications in CSP are synchronous in the sense of Ticc. User may skip waiting for a message by using guard statements. CSP has its own pathways for exchanging messages. However, pathways in CSP are implicit. They do not have an explicitly defined structure. They are built into the processes that exchange messages. They do not provide a level of abstraction that decouples data exchange details from network connectivity or computations performed by processes. Thus, they cannot be dynamically changed or updated. Introducing or removing a pathway would require program rewriting. Most importantly, pathways do not carry with them execution environments to process received data. Methods used to process data are built into the sending and receiving processes. CSP is not used in parallel programming, although there are parallel programming languages based on CSP [38]. It is used mostly in operating systems.

π-calculus: This specifies the mathematical foundations of a framework [42, 43, 44, 45] for describing many types parallel and concurrent process interactions, and indeed defines parallel computations definitively. As mentioned earlier, it is weak on issues of synchronization, coordination and abstractions. It does not provide explicit controls for synchronization. Applications of the ideas in π-calculus to practical parallel programming methodologies have not emerged yet. Some structural and operational components of Ticc-Ppde, such as (i) dynamically changeable connection oriented communication, (ii) automatic process activation based on message exchange events and (iii) local and remote pathways and memory environments of Ticc-Ppde over lap with those used in π-calculus. Property (iii) in Ticc-Ppde follows from use of virtual memories and component encapsulation in Ticc-Ppde (Section 7.6). Pathways and memories of encapsulated components will not be accessible to parts of network that are outside the encapsulation. This is similar to use of restricted names in π-calculus.

We will now proceed to describe the Ticc communication system and network models of parallel computation that they naturally give rise to.

A Note of Caution: The infrastructure described below might seem quite formidable at first reading. It should, however be noted, the concepts are very easy to implement. Ticc and Ticc-Ppde prototypes were implemented in C++ by one person (this author) in two and a half years.

5.2. Causal Communication Primitives (Ccp's) and Pathways

Ccp: (Ticc & Ticc-Ppde) We add a new kind of programming primitive to programming language, besides assignment, if-then-else and while-statements. It is called Causal Communication Primitive, Ccp¹. It has the form “X: x→Y;” where X is the context (signal sender) of the Ccp, x is a one or two bit control signal and Y is the signal recipient. X can be a Cell, a Port, or an Agent. The same holds for Y. There are six versions of Ccp:
¹We have changed the format of Ccp in Ticc-Ppde from the one used in Ticc.

| | | |
|---|---|---|
| i) | cell: c → port; | //port should be tuned to cell. |
| ii) | port: c → agent; | //agent should be tuned to port. |
| iii) | agent1: s → agent2; | //may send s to itself. |
| iv) | agent: s → port; | //port should be tuned to agent. |
| v) | agent: s → [P₁, . . . , Pₖ]; | //agent to a group of ports. |
| vi) | port; s → cell; | //cell should be tuned to port, |

where c is a completion signal and s is a start signal. Ccp is similar to assignment in that it sets values of signals associated with cells, ports and agents. Whereas the effect of an assignment action is immediate, the effect of Ccp is not immediate. It causes certain things to happen. A sequence of Ccp's when evaluated, will cause signals to travel along a pathway (FIG. 3) and this will eventually cause a message to be delivered to recipient cells.

Structure of Pathways: (Ticc) Pathways have a rather complex structure. FIG. 3 illustrates a simple pathway connecting two ports P1 and P2 of cells C1 and C2, respectively, and containing two agents A1 and A2 on the clockRing that surrounds a virtual memory M. A1 and A2 are connected to P1 and P2, respectively, by watchRings. Cells, ports, agents, clockRings, virtualMemories and watchRings are all C++ classes with data and methods defined for them. Each Ccp is compiled and executed over these C++ classes, in the same manner as any other programming statement is compiled and executed over a priori defined data structures and methods, without invoking the assistance of an operating system.

(Ticc) The Ccp-sequence [1] in FIG. 3 is associated with generalPort P1 through which the message will be sent, and the sequence [2] is similarly associated with functionPort P2 through which the reply will be sent. We will use CcpSeq(P1) and CcpSeq(P2), respectively, to refer to them. Every time a message is sent from generalPort P1 to functionPort P2, signals will flow along the simple pathway in FIG. 3 from P1 to P2 (dotted blue arrows). When the reply message is sent from P2 to P1, signals will flow from P2 to P1 (dotted orange arrows). A second message may be sent from the generalPort only after receiving the reply.

[image]

(Ticc) Ticc evolved from earlier works on Harmonic Clocks [31] RESTCLK [32]. Pathway structures introduced here are similar to those introduced in [32], but signal transmission protocols used by Ccp are different from the protocols used in RESTCLK and Harmonic Clocks. Ccp protocols guarantee high-speed message delivery without message interference, and led to successful applications to parallel programming, while Harmonic Clocks and RESTCLK did not do so.

(Ticc) Control Signals: In a Ccp of the form “X:x→Y;” X and Y will have states. A signal x can be one of two types: a start or a completion signal, where each may have upto four subtypes. The three subtypes of completion signal will each specify one of three possible alternatives: (i) send: switch R and W (ii) forward: don't switch R and W or (iii) halt computations. Each subtype of start signal will specify one of four possible choices: (i) broadcast signals to ports, or post one of the following three notifications on a port, (ii) waiting-for-message, (iii) message-ready or (iv) pathway-ready.

Tuning: (Ticc) In any Ccp, “X: x→Y;” Y will receive x and respond to it only if Y is in a state, in which it is expecting to receive a signal of the type of x. X and Y are said to be tuned to each other if X or Y will never fail to receive and respond to a signal sent by the other. Tuned pairs (X, Y) will thus be always listening to each other at right times. The next state to which Y transfers itself will always be such that it will be the appropriate state to respond correctly to the next signal that Y will receive.

(Ticc) Tuning of successive agents around a virtual memory is enforced by the clockRing. Tuning of an agent to ports connected to it is enforced by watchRings. Proper tuning is facilitated by the fact that in successive instances of message-flow along a pathway the direction of signal flow would alternate only between two possible choices. The clockRing and watchRings on a pathway will force the state of each entity in the pathway to switch in synchrony with the expected direction of next message-flow along that pathway. This guarantees that it would be always possible to pass signals along any pathway with no need for dynamic state or type checking, or synchronization sessions. This contributes to low latency message exchanges.

Semantics of Ccp: (Ticc) When a Ccp, “X: x→Y;” in a Ccp-sequence is evaluated it will cause Y to sense x, and perform the following. (a) Some book keeping logical operations (details not important here), (b) change its state, and (c) cause Y to either send an appropriate signal to the next object Z that follows Y in the pathway and then return SUCCESS, or (d) return FAILURE. If “X: x→Y;” is immediately followed by “Y: y→Z;” in a Ccp-sequence, then the second statement will be executed only if the first one returned SUCCESS. Otherwise, evaluation of all subsequent causal statements in the Ccp-sequence, after “X: x→Y;” will be abandoned.

5.3. Evaluating Ccp-Sequences

(Ticc-Ppde) A Ccp-sequence, CcpSeq(P₁) may be evaluated by the parent cell of P₁, or a (Ticc) Ticc-virtualProcessor (not shown in the figure) associated with the parent cell, or a (Ticc) communications processor implemented in hardware together with CPU. As mentioned earlier, evaluation of CcpSeq(P₁) will cause signals to travel along the pathway attached to P₁ (see FIG. 3) and cause the message in the virtualMemory of the pathway to be delivered to its intended recipients. The three modes of evaluations and their characteristics are described below.

By Cell: (Ticc-Ppde) If the thread of P₁ evaluates CcpSeq(P₁), then message delivery will be immediate. The thread will use “P₁→sendImmediate( );” (“forwardImmediate( )”) to send (forward) the message immediately². All tests reported in Section 8 used sendImmediate( ). This is the normal mode of Ccp-evaluation in most parallel programs. Terms Th(fP, m2) and Th(gP) in equations (1) and (2a) in the SUMMARY embed these operations.
²It will use “P₁→halt( )” in all cases to halt computations.

By VirtualProcessor: (Ticc) VirtualProcessor is a C++ object that is used both to execute Ccp-sequences, when necessary, and to keep data related to CPU assignments and dynamic process scheduling. Every cell will have a unique virtualProcessor associated with it, but each virtualProcessor may service more than one cell. A cell may delegate evaluation of a Ccp-sequence to its associated virtualProcessor at any time, if a CPU is available to run it. Cell will use “P₁→send( );” (or “P₁→forward( )”) to do this, where P₁ is the port of the cell though which message is being sent. VirtualProcessor will maintain a queue of pending Ccp-sequences and evaluate them in the order they were received, in parallel with computations performed by cells. Advantage is, it will cut grain sizes of cells by 400 nanoseconds. Disadvantages are, message delivery may not be immediate and CPU overhead will increase since each virtualProcessor will require a dedicated CPU to run it. Each virtualProcessor may send more than 2 million messages per second.

By Communication Processor: (Ticc) VirtualProcessor may be implemented in hardware as the communications processor of a CPU. Since each cell has a unique CPU, each cell will then have a unique communication processor as well. In this case, when a thread calls “P→send( );” (or “P→forward( )”) the corresponding Ccp-sequence, CcpSeq(P), will be executed immediately by the communication processor of the cell's CPU, in parallel with computations being performed by the cell. Thus, the grain size of the cell will not increase. The number of messages that may be sent at any time will be limited only by the number of available CPUs. The communication processor hardware will require capabilities to perform logical operations on bits of a 32-bit register, simple small integer additions, and at most 128 such registers.

Using virtualProcessor or communications processor allows cells to devote all their time only to computations. This is useful when it is necessary for cells to distribute data being received from an external source at very high speeds. Cells may distribute received data at high speeds to their destinations without having to spend time to send messages.

[image]

Pending-Flags: (Ticc) Each Ccp in a CcpSeq(P) is associated with a pending-flag. This flag will always be set to true, before evaluation of CcpSeq(P) begins. It would be reset to false only after the message associated with CcpSeq(P) had been delivered, or evaluation of CcpSeq(P) was abandoned. Pathways or cells will be dynamically changed only if all of its associated pending-flags are false. We will later see how these are used to facilitate dynamic updating (Section 7.3).

5.4. Compound Pathways

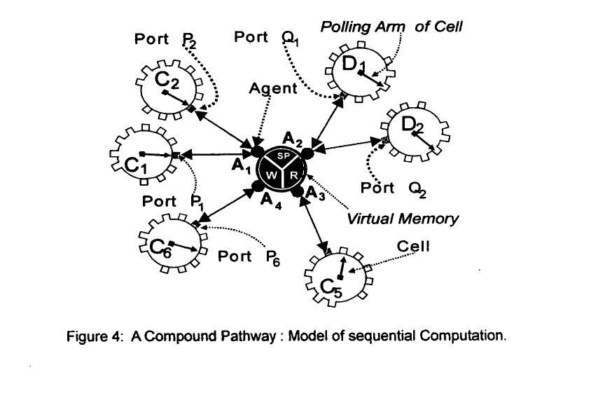

Structure: (Ticc) In a compound pathway, FIG. 4, there may be several agents around the virtual memory of the pathway (see Section 8.2 for an example of use of a compound pathway with just one agent). Each such agent may be tuned to several ports, each port belonging to a distinct cell. Cells whose ports are thus tuned to the same agent are said to form an ordered group. Thus, cells [C₁, C₂] and [D₁, D₂] in FIG. 4 form ordered groups. Each cell in such a group will run in parallel with other cells in the group, each in its own assigned CPU. In FIG. 4, a message sent by [C₁, C₂] will be delivered to [D₁, D₂] and a message sent by [D₁, D₂] will be delivered to cell C₅. Messages will thus travel around the clockRing from one group to another in clockwise direction. CcpSeq(Pᵢ) for i=1, 2, in FIG. 4 will be,
CcpSeq(P)=[Cᵢ: xᵢ→Pᵢ; Pᵢ: x₁→A₁; A₁: s→A₂; A₂: s→[Q₁, Q₂]; [Q₁: s→D₁; Q₂: s→D₂;]. (Eq1)
Agent A₂ broadcasts start signal s to all ports in [Q₁, Q₂]. In general, when a group G₁=[Cᵢ|1≦i≦m] with ports [Pᵢ|1≦i≦m] tuned to agent Al sends a message to group G₂=[Dⱼ|1≦j≦k] with ports [Qⱼ|1≦j≦k] tuned to agent A₂, CcpSeq[Pᵢ] for 1≦i≦m will be,
CcpSeq(Pᵢ)=[Cᵢ: xᵢ→Pᵢ; Pᵢ: xᵢ→A₁; A₁: s→A₂; A₂: s→[Q₁, . . . , Qₖ]; [Q₁: s→D₁; . . . Qₖ: s→Dₖ;]. (Eq2)
Thus it may be noted, when a group with m cells sends a message to a group with k cells, for each port Pᵢ of the sending group, 1≦i≦m, its CcpSeq(Pᵢ) will contain (4+k) Ccp's.

Tuning Conventions: (Ticc-Ppde) We will say a port is tuned to a virtual memory if it is tuned to an agent on that memory, and a cell is tuned to an agent if one of its ports is tuned to the agent. No two ports of the same cell may ever be tuned to the same virtualMemory. Ports tuned to the same agent should be either all generalPorts or all functionPorts, or same kind of designated ports (see FIG. 1). All cells in a group will have the same message broadcast to them with in a few nanoseconds of each other. Each cell in the group may however, use different components of that message, thereby eliminating memory contention.

5.5. Tasks Performed by Agents and Ports

Security Checks: (Ticc) When a Ccp of the form “Aₗ: s→A₂” (third Ccp in Eq1 and Eq2 above) is evaluated in a Ccp-sequence, where A₁ and A₂ are agents, A₂ will begin broadcasting start signals to ports tuned to it. A₂ will send start signal only if the port satisfied certain a prior specified security conditions. Application system message security may thus be enforced at the lowest message passing level. Latency measurements we made ([28a,b] and Section 8.1) included security checks. If security checks are not needed, they may be turned off. This kind of security check infrastructure can play a significant role in database, business and intelligence processing parallel applications. We will not enter into details here.

Message Delivery: (Ticc) The port Qⱼ for j=1, 2 in FIG. 3 will perform message driven cell activation when “A₂: s→Q₁, Q₂];” is evaluated (see Eq1), i.e. when start signal broadcast by A₂ is received by ports Qⱼ for j=1, 2. When Qⱼ receives a start signal. Qⱼ will post a message-ready signal on itself. We will refer to this posting as message delivery.

Enforcing Agreement Protocol: (Ticc) Suppose m cells, G₁=[Cᵢ|1≦m], in an ordered group with ports [Pᵢ|1≦i≦m] tuned to agent A₁ send a message to k cells in a receiving group, G₂. Since cells in such groups operate in parallel, each cell Cᵢ in G₁ will evaluate its CcpSeq(Pᵢ) in parallel with other cells in G₁, when it sends out its message. In each CcpSeq(Pᵢ) the second Ccp has the form “Pᵢ: xᵢ→A₁;” (see Eq2) where xᵢ is a subtype of completion signal sent by port Pᵢ to agent A₁. Each cell in G₁ will check completion signals received by agent A₁. This check is called agreement protocol check. It will perform this check in parallel with other cells in G₁, while it evaluates “Pᵢ: xᵢ→A₁;” i.e., when A₁ receives completion signal from Pᵢ.

(Ticc) Agreement protocol check has two parts to it: we will refer to them as AP1 and AP2. AP1: For all i, 1≦i≦m, (xᵢ>0), where xᵢ is the completion signal sent by port Pᵢ to A₁, xi>0. This will hold true only if A₁ had received a completion signal from Pᵢ. While evaluating “Pᵢ: xᵢ→A₁;” in CcpSeq(Pᵢ), each Cᵢ will first check for satisfaction of AP1, namely whether A₁ has received completion signals from all cells in the group. It would return FAILURE if AP1 was false at the time it was evaluated. Once FAILURE was returned, of course, Cᵢ would abandon evaluation of all subsequent Ccp's in CcpSeq(Pᵢ) as per semantics of Ccp, and proceed to poll its next port.

(Ticc-Ppde) Thread-lock associated with AP1 checking will make sure that only one cell, say cell Cⱼ for some j, Cⱼ in [Cᵢ|1≦i≦m], will succeed in AP1 testing. Let Pⱼ be the port of Cⱼ, Pⱼ in [Pᵢ|1≦i≦m]. Let us now suppose that it takes on the average t nanoseconds of time to evaluate a Ccp. Each Cᵢ would have to evaluate almost two Ccp's in CcpSeq(Pᵢ) in order to check AP1 and return FAILURE. The (m-1) cells in G₁ that failed in AP1 testing would have thus together spent less than at most [(m-1)2t] nanoseconds, since they worked in parallel. The winner, Cⱼ, will then do AP2 checking. All Cᵢ≠cⱼ] may immediately proceed to poll their respective next ports.

(Ticc & Ticc-Ppde) AP2 is defined by, AP2=B[xᵢ|1≦i≦m], where B is a Boolean condition on subtypes of completion signals, xᵢ, received by A₁³. Condition B checks for a priori defined compatibility conditions on completion signals. Details are not important here. If AP2 test succeeded, then Cⱼ will continue with evaluation of all (k+4) Ccp's in CcpSeq(Pⱼ) (see Eq2), where k is the number of cells in the receiving group G₂, and cause a new message to be sent, or old message to be forwarded, or computations to be halted, as the case may be, depending on subtypes of received completion signals. It will spend a total time of [(k+4)t] nanoseconds to evaluate CcpSeq(Pⱼ). In all cases message will be delivered or forwarded exactly once, if computations are not halted. Message in the read-memory R will always be protected until all cells that received the message had fully responded to it. If AP2 test failed then an error condition will be generated and no message will be delivered. It may be noted, cells in a sending group, like group G₁, may always use their scratchpad memory to coordinate completion signals they send to agent, like agent A₁, and thus avoid AP2 test failure. Total time spent to deliver a message from m sending cells to k recipient cells will be less than at most [[(m-1)2t+(k+4)t]+kd] nanoseconds, where d nanoseconds is the time taken by each receiving port to deliver the message to its parent.
³There are differences in the way AP2 is used in Ticc and Ticc-Ppde.

(Ticc-Ppde) In a 1.5 Gigahertz/sec CPU, t is of the order of 78.8 nanoseconds, and d is of the order of 2 nanoseconds when there are no cell activations involved. Thus the time for message delivery, while the cells are already running, will be at most [(2m+2+k)78.8+2k] nanoseconds. In the latency test described in Section 8.1 m=k=1 was true, and the latency for 0-byte message was 396 nanoseconds. The above figures are based on this.

Delivery Self-Synchronization: (Ticc-Ppde) This is done when a Ccp of the form “A₁: s →A₂;” is evaluated, where A₁ and A₂ are agents (third Ccp in Eq2). It will cause start signals to be broadcast to ports tuned to agent A2. There are two levels of self-synchronization in Ticc during message delivery, with increasing costs in time. In the first level, when an agent broadcasts start signals to ports in a receiving group, the ports in the group will post message-ready postings on themselves with in kd nanoseconds of each other, where k is the number of cells in the receiving group. We refer to this as Level-1 synchronization. Each cell in the receiving group will receive and process the message at the time it polls the port to which the message was delivered. Here it is quite possible that a cell in the receiving group started to process the delivered message before message-ready notifications had been posted on all ports in the group.

(Ticc-Ppde) In Level-2 synchronization, cells in a group may begin processing delivered message only after message-ready notifications had been posted on all ports in the receiving group. In this case, ports in the receiving group would all get their respective message-ready notifications with in n nanoseconds of each other. In normal mode of operations, only level-1 synchronization is used.

Send Self-Synchronization: (Ticc-Ppde) Level-3 synchronization pertains to messages sent out by cells in a group. When cell Cᵢ in a group uses “Pᵢ→sendImmediate( );” or “Pᵢ→forwardImmediate( );” Cᵢ will execute CcpSeq(Pᵢ) using CPU assigned to it, in parallel with other cells in the group. However, execution of the CcpSeq(Pᵢ) will succeed only if AP1 described above is satisfied. Otherwise, in Level-1 synchronization, Cᵢ will abandon CcpSeq(PI) execution and may proceed immediately to poll its next port. Level-3 synchronization will guarantee that no cell in a group would proceed to poll its next port until exactly one of them had succeeded in AP1 testing and has delivered message to the receiving group. This mode of synchronization is useful while running a Ticc-network in the debug mode (Section 7.2).

(Ticc-Ppde) These facilities make it possible to run parallel programs with automatic self-synchronized asynchronous execution with high efficiencies, fully exploiting the available high-speed communications with guaranteed message delivery.

### 6. TICC MODELS OF COMPUTATION

Single Group Restriction: (Ticc) Please refer to FIGS. 3 and 4. At any given time, only one group of cells around the virtual memory of a pathway may be active responding to a message received from that virtual memory. This is a very important restriction; we will refer to this as the single group restriction. Since each cell around a compound pathway runs in its own distinct CPU, in parallel with other cells, while cells in one group are responding to a message received from the virtual memory, other cells in the compound pathway outside this group may service their other ports not tuned to the same virtual memory. Since only cells in one group will be accessing and updating virtualMemory at any given time, one may suitably organize data in virtualMemory, and allocate virtualMemories themselves in a manner that minimizes memory contention and memory blocking.

6.1. Model of Sequential Computations

Ticc-Sequential Computation: (Ticc) Sequential computation in Ticc will migrate from one group to its next around a virtualMemory in clockwise direction, synchronized by message receipts. Computations will continue indefinitely until they are stopped by one of the groups around the virtualMemory. Even though all cells around the memory run in parallel independently, each in its own CPU, computations migrating around the virtual memory will be sequential. This migration is clocked by the clockRing as one group completes its computations and sends message to its next group; hence, the name clockRing. This is the model of Ticc-sequential computations. Configurator may be used to start such sequential computations by initializing the read-memory R of a compound pathway and injecting a start signal into one of the agents on the virtual memory that is tuned to functionPorts. This will activate all cells tuned to that agent and begin computations around the virtualMemory.

Buffer-free Communication: (Ticc) In such a sequential computation each group will receive its next message only after computations had migrated through all groups. Thus, no group will receive a second message while it is still working on its first one. Hence, there is no need for the virtual memory to hold more than one message at a time. This is a consequence of the single group restriction. We call this buffer-free communication because not only are there no message queues, but also virtual memories play a role in providing execution environments for methods used to respond to messages. Messages are never copied, unless copying was forced by computations performed on messages.

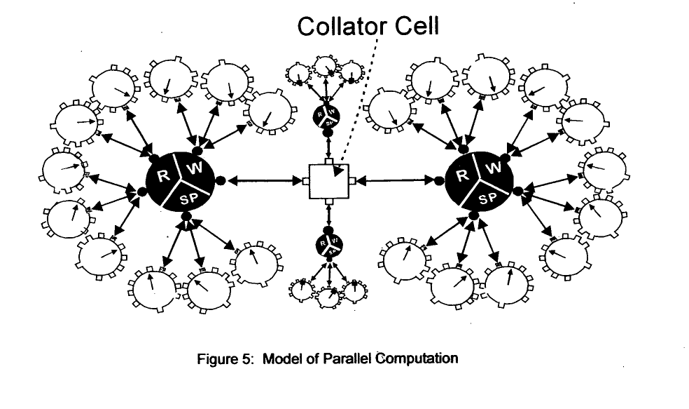

Structure of Parallel Computations: (Ticc) FIG. 5 illustrates the model of Ticc-parallel computations. It consists of a collection of compound pathways each running its own Ticc-sequential computation. Each compound pathway in the network will communicate with another by using specialized cells, called collator cells. It is the job of collator cells to receive data from different compound pathways, collate them, format them and send them to groups of cells in one or more of the pathways that are connected to it. Collator cells will do this at each step only when all needed data are ready and are properly collated. Collator cells will not contain any memory. They will instead use the virtual memories of pathways connected to them.

6.2. Model of Parallel Computations

[image]

(Ticc-Ppde) In Ticc, pollPorts( ) did not have threads associated with them. Ticc-Ppde associates threads with pollPorts( ) and redefines parallel computations in terms of these threads.

Buffer-free Parallel Processing: (Ticc) Since parallel computations are defined by (i) a collection of inter-communicating compound pathways, (ii) computations in every compound pathway are buffer-free and (iii) collator cells do not contain any memory, one may conclude that all Ticc based parallel computations will always be buffer-free in the sense defined above.

6.3. Inherently Parallel (Concurrent) Interactions in Ticc-Ppde

Robin Milner's Turing commemorative lecture [41] eloquently articulates the need for transition from sequential computations to concurrent interactions. π-calculus provides the basis for such a transition. This is what formalisms like OCCAM [38], Petri Nets [39], CCS [44] have successfully done to varying degrees of elegance, generality and practicality. π-calculus unifies them. It is instructive to examine the role abstractions played in this evolution.

In assembly language programs control structure is explicit. This is true also in high-level parallel languages like Petri Nets [39] and Parallel Fortran [40]. Descriptions of interactions in π-calculus are similar in many ways to assembly language descriptions of computations. Control structure of parallel computations is explicit and could be non-deterministic. Layers of abstractions might be necessary before π-calculus is reduced to a practical parallel programming framework. It is possible that one could define useful π-calculus abstractions in the bigraph [45] model.

In high-level sequential programming languages, control structure is implicit, driven by the semantics of programming language statements, like If-then-else, for, while statements and function invocation statements. As Milner points out, [41] object oriented languages took this abstraction one level higher and began to shift focus to interactions, instead of operations. In high-level sequential programming languages, user focuses only on the semantics of activities to be seed, not on the control structure of how they interact. This makes sequential programs easier to write, more readable and understandable.

OCCAM [38] provides abstractions that help make some concurrent control structures implicit and dynamically dependent on actions performed by objects. However, computation, message passing and pathways are inextricably intertwined with each other. No abstraction decouples pathway and message details from message transfer and computations. In addition, operators are needed for dynamic activation and termination of parallel (concurrent) processes.

In Ticc-Ppde, control structure of parallel program interactions is implicit, just as in high level sequential programming languages. Ticc-Ppde naturally extends the sequential object oriented paradigm to parallel computations. The construct used in Ticc-Ppde for implicit specification of process interaction is “sendImmediate( )”. But sendImmediate( ) just sends a message. This naturally merges with the semantics of activities performed by a cell. It does not look like a construct intended for process activation and process control.

As mentioned earlier, dynamic control structure of process activations and process interactions in Ticc-Ppde networks are isomorphic to dynamic message flow structure. All parallel process activations and interactions are driven by message exchange events. User who writes a parallel program in Ticc-Ppde has to focus only on the semantics of activities performed by a cell, not on the control structure of how they interact with other cells. This makes Ticc-Ppde parallel programs easier to write, and easier to read and understand.

In all cases, receipt of messages will automatically coordinate computations, synchronize them when necessary and activate them. No user intervention is necessary. This is similar to data-flow activated asynchronous hardware systems.

6.4. Adapting to Distributed Memory Supercomputers

Degree of Sharing: (Ticc-Ppde) We have assumed that g is the maximum port-group size. We will refer to g as the degree of memory sharing, because ports belonging to a port-group should be able to read messages delivered to them from a shared read-memory. Let the maximum number of ports a cell may have be n. We will refer to this as the degree of cross memory writing, because n together with g will determine an upper bound on the number of distinct groups that should have the capability to write into a shared memory not belonging to those groups.

Cross Memory Writing: (Ticc-Ppde) A cell C with n ports may have n different pathways connected to it Each one of these pathways may have a port-group of g ports connected to it at its other end. Parent cells of these ng ports would each run in its own distinct dedicated CPU. Thus, at most ng different CPUs could potentially attempt to write into the local shared memory of C. This is an extremely large upper bound not likely to be ever reached in any parallel computation. One has to experiment with systems and programs to get representative values.

(Ticc-Ppde) Complexity of memory interconnects for a distributed shared-memory Ticc supercomputer will depend on values of g and n. We think, practical systems could be built with ng=100. The point to note here is, memory organization for supercomputer designs for Ticc are likely to be different from the ones that are currently used in supercomputers. This problem needs further study.

### 7. IMPLEMENTATION AND TICC-GUI IN TICC-PPDE

7.1. Classes

(Ticc-Ppde) Ticc-Ppde provides a Ticc-Gui⁴ to build Ticc-networks, start and run parallel programs, and debug and modify them as needed. The last two are still under design and development All diagrams shown in this paper follow the Ticc-Gui format. The implementation consists of following classes: (1) Cell (Units of parallel computation) with subclasses, Configurator (Used to set up Ticc-network and modify them), Csm (Performs network related services to Cells), Collator (Collects and distributes data), and Monitor (Monitors activities in Ticc-network). (2) CellFactory (Defines and installs Cells with specified number of ports, port characteristics, and their security and privilege specifications); (3) Port (Allows cells to communicate with other cells and access virtual memories); (4) ClockRings (Encapsulates VirtualMemories, tunes agents) (5) Agent (Installed on ClockRings as needed. Collects and distributes signals, checks agreement protocols and
⁴Ticc-Gui was implemented by Kenson O'Donald, Manpreet S. Chahal and Rajesh S. Khumanthem, according to specifications given by this inventor. synchronizes message delivery to cells in groups); ImAgent (Input Monitor Agent) and OmAgent (Output Monitor Agent) are subclasses of Agent; (6) WatchRing (Connects Agents on ClockRings to Ports on Cells. Enforces tuning); (7) VirtualMemory (Holds message and supports computations on the message); (8) Message (Encapsulates Data in VirtualMemories); (9) VirtualMachine (Used for message passing and book keeping) with subclass, HealthDoctor. HealthDoctor is used to monitor performance at ports, detect malfunctions and initiate self-repair. Ticc-provides the infrastructure for this by using the HealthDoctor to check times taken by ports to respond to messages against nominal ranges of times specified a priori for each port in a Ticc-network (analogous to checking pulse). Research and experimentation are necessary to learn how this facility may be used effectively.

7.2. API & Gui in Ticc-Ppde

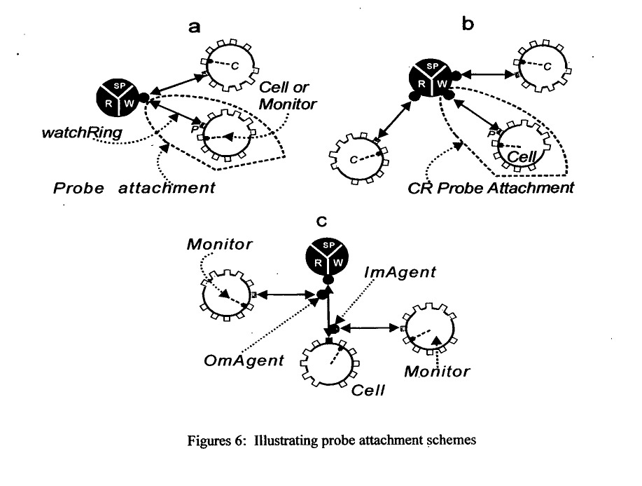

(Ticc-Ppde) API provides commands with suitable arguments to build and modify Ticc networks. Networks are built by installing cells (FIG. 1), simple pathways (FIG. 3) and probes (FIGS. 6a through 6c). Compound pathways are built by attaching probes to simple pathways as needed. We will refer to installed items as network components. Ticc-Gui provides convenient user interaction facilities to invoke methods in API, install components, and display them on Gui screen as soon as they are installed. API commands are briefly described below and illustrated in FIGS. 3 through 7.

(Ticc-Ppde) Commands in API: InstallCell: Installs a cell of a specified subclass using CellFactory. InstallPathway: Installs a simple pathway shown in FIG. 3, with given memory sizes. Install Probe: Probe is a cell with a watchRing attached to one of its ports. It is installed by connecting the watchRing to a specified agent (FIG. 6a). InstallCrProbe: (FIG. 6b). Cr-Probe is a Probe with an Agent attached to the free end of its watchRing; installs Cr-Probe on a clockRing at a specified place. InstallMonProbe: A monitor probe is a probe with a Monitor instead of a Cell. It is attached to an agent as shown in FIG. 6a and is used to introduce breakpoints in parallel computations as explained later below. InstallnMonProbe: IM-Probe is an Input Monitor probe. It is like a CR-probe with an ImAgent, instead of regular Agent. It is attached to a watchRing near the port end of watchRing as shown in FIG. 6c. It is used to trap data flowing into port and dynamically examine or modify them before they are given to the port. InstallOutMonProbe: OM-Probe is an Output Monitor probe. Like an IM-probe but with an OmAgent instead of an ImAgent. It is attached to a watchRing near the Agent end of watchRing as shown in FIG. 6c and is used to trap data flowing out of port and dynamically examine or modify them before sending them out.

(Ticc-Ppde) One can browse through a Ticc-network using Ticc-Gui. After creating a network, it can be saved and reloaded at a later time when needed. Cells in a network may be programmed to dynamically install or remove any network component with out disturbing ongoing parallel computations.

(Ticc-Ppde) There are several other commands in API that are used in Ticc parallel program specification. We encountered some of them like, messageReady( ), pollPorts( ), etc., in our discussions earlier. A complete list of all API commands may be found in the Ticc-Ppde user manual [29] (in preparation).

7.3. Dynamic Updating

(Ticc-Ppde) Pending & Agent Flags: Two facilities in Ticc-Ppde make it possible to dynamically change pathways and cells without interfering with ongoing computations. One is the pending-flags facility mentioned in Section 5.3. The other is the agent-flag used with every agent. An agent will temporarily suspend its operations if its agent-flag is false and resume it only when it becomes true.

[image]

(Ticc-Ppde) If a pending-flag is true it indicates that a message is due to arrive at some ports. Clearly, if an update would affect the flow of this message to those ports then it should be not be done before message delivery. Update could be done only after the pending-flags associated with those ports all become false. As pending-flags that interfere with a given update become false, one may temporarily block new messages from arriving at or being sent out from affected ports by setting the agent-flags to false for agents tuned to those ports. This will temporarily block traffic in affected pathways, thus allowing the updates to be done. By resetting the agent-flags to true after updates are done one may cause normal operations to resume.

(Ticc-Ppde) Pending-flags and agent-flags are thus used to suitably modulate updating processes so that updating does not interfere with ongoing computations. This becomes possible in Ticc only because Ticc is self-scheduling and self-synchronizing. When message traffic is blocked in certain portions of a parallel computation network, other portions will automatically adjust their activities, by either slowing down or waiting for normal operations to resume.

(Ticc-Ppde) Facilities for this kind of updating are built in features of Ticc-Ppde. Pending-flags and agent-flags are automatically checked before every installation of a network component at any time. Thus, this kind of checking is not something that an application programmer should articulate. There is no need for an application programmer to anticipate and provide special facilities into an application program to accommodate updating contingencies that might be encountered during the lifetime of an application.

7.4. Dynamic Debugging in Ticc-Ppde

(Ticc-Ppde) Parallel Breakpoints: In the case of monitor probe shown in FIG. 6a there is a special situation. Here the monitor cell of the monitor probe will join the group, say group G that is already tuned to the agent to which the monitor probe is attached. Thus, in each cycle of computation messages written by cells in G into virtual memory of the agent will be sent to the next group only after the monitor cell also has sent its completion signal to the agent. One may cause the monitor cell to do this only when it receives an appropriate trigger signal via its interrupt port. This trigger input may be controlled externally using a “mouse click”. Until the trigger is issued, further computations performed by cells in the group may be halted using Level3 synchronization (Section 5.3). Since parallel computations in Ticc-Ppde are self synchronizing and are message driven, when computations in one group is halted or delayed the rest of the network would adjust to it automatically in the appropriate manner.

(Ticc-Ppde) Thus, one may use monitor probes to introduce parallel breakpoints simultaneously at several points in a Ticc-network where agents are attached to virtual memories. Each monitor cell will run in its own assigned CPU, in parallel with all other cells in a network. We are now designing and developing a dynamic parallel debugging facility for parallel programs using this feature.

7.5. In situ Testing and Dynamic Evolution in Ticc-Ppde

Dynamic Evolution: (Ticc) A useful application of dynamic monitoring in Ticc is in situ testing of new versions of a cell in the same network context in which the old version works, without interfering with ongoing computations. This facility is useful to modify a network to meet new requirements or to correct bugs in existing code.

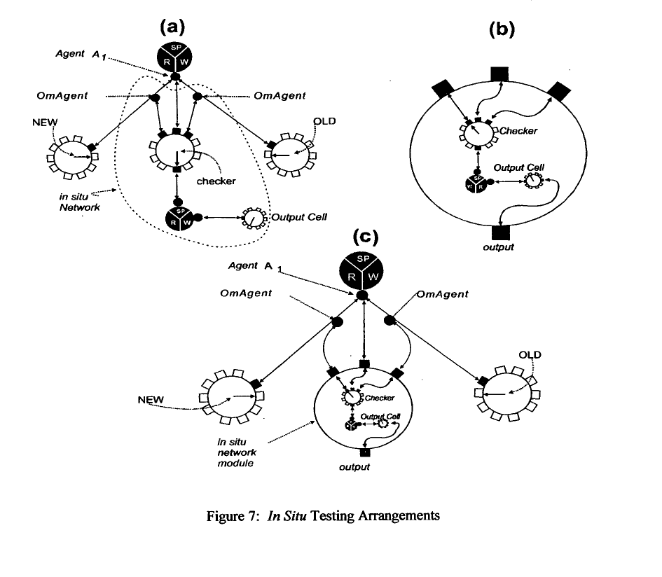

(Ticc) The network arrangement for in situ testing is shown in FIG. 7(a). Cells OLD, NEW and Checker are all tuned to the same agent and work in parallel. Thus in each cycle of

[image]

computation they will all get the same inputs. OLD and NEW will write their responses into the virtual memory to which A₁ is attached. These outputs will be trapped by Checker using the OmProbes shown in the figure. Checker will check these outputs against each other and send its result to the output cell in FIG. 7(a). The outputs produced by the output cell may be viewed dynamically. After sending the output, Checker will delete from the virtual memory the message written by NEW and then only send completion signal to A₁. At that point, A₁ will forward the message to the next group. Thus, the rest of the network would not even know that NEW had been installed in the network. When checking is satisfactory, the in situ network, OmProbes, OLD cell and watch ring connecting OLD to agent A₁ may all be removed, thus leaving NEW in the network to take over the work of OLD. This will result in dynamic updating of the network with NEW in place of OLD.

7.6. Component Based Development

(Ticc-Ppde) Use of component based parallel program development is illustrated in FIGS. 7(b) and 7(c). FIG. 7(b) shows the encapsulated version of the in situ network module. This module may be used as shown in FIG. 7(c) if a normalized Checker is used, whose operations are parameterized with OLD and NEW. This kind of software network module can be plugged into any network in the same way as hardware modules are plugged into larger hardware systems. Network encapsulation facilities and software module libraries have not yet been implemented in Ticc-Ppde.

We now present the parallel Latency-Test and the FFT_Scalable test that were performed on parallel programs written with Ticc-Ppde.

### 8. TICC-BASED PARALLEL PROGRAMS DEVELOPED IN TICC-PPDE

8.1. Parallel Latency Test (August 2004)

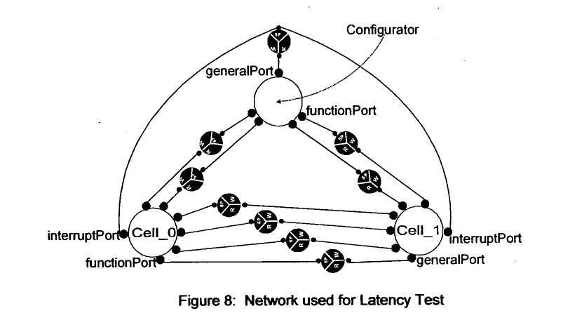

Network used for parallel Latency-Test program and performance results are shown in FIG. 8. Data on performance in T3D supercomputer shown in Table II was obtained from reference [27], others from [37]. We believe, the results presented here are promising, and give hope that latencies in Ticc would be much less than latencies in other systems.

Configurator was used to set up the network and start computations by sending an interrupt signal from its generalPort to the interruptPorts of cell_{—}0 and cell_{—}1 (see generalPort at the top of Configurator in FIG. 8). These two cells then exchanged messages of specified length, ranging from 0 bytes to 10,000 bytes with each other for about 300,000 to 600,000 times in each execution session. Cells sent out messages from their generalPorts and received messages from other cells through their functionPorts. Each cell received and responded to messages asynchronously, i.e., it used “P→messageReady( );” to check for a message at port P, responded to it if there was one, or else immediately polled its next port. Every time a cell received a message, it copied the message into the virtualMemory of a pathway that connected it to the Configurator and sent it off to the Configurator. After doing this, it responded to the received message by constructing and sending a reply message to the other cell. When the Configurator received a message from a cell, it copied it and saved it in an output message vector. Thus, each message was written once and copied twice.

[image]

TABLE II
Latency Comparisons
HALO Exchange Timings in CRAY X1, Jan/Feb 2005 [37]
and T3D Supercomputer (1997) [26]

| | MICROSECONDS | | | | | | |
|---|---|---|---|---|---|---|---|
| | | | | | MPICH in T3D | | |
| | | | | | SuperComputer | | |
| | CO ARRAY | | | | 1 Gigabits/sec | TICC | |
| BYTES | FORTRAN | UPC | SHMEM | MPI | Memory bus | HP Proliant | BYTES |
| 1 | 14 | 22 | 23 | 60 | 20 | 0.4 | 0 |
| | | | | | 45 | 1.0 | 64 |
| 10 | 14 | 20 | 24 | 60 | | | |
| | | | | | 65 | 1.4 | 128 |
| 100 | 14 | 20 | 28 | 75 | 120 | 1.6 | 256 |
| | | | | | 155 | 2.5 | 512 |
| 1000 | 22 | 28 | 40 | 95 | 190 | 3.5 | 1024 |
| 10000 | 100 | 120 | 150 | 180 | ?? | 45 | 10240 |

Each cell associated a distinct number with each message it sent, including reply messages. All exchanged messages and replies were of the same length, and each was constructed afresh every time a message or reply was sent. Latency times shown in FIG. 8 included in them the times needed to construct and copy messages, and to perform security checks. Since there are three active cells in this network, at any given moment upto three messages may be exchanged in parallel.

At the end of 300,000 or 600,000 such message exchanges, total time taken was divided by the total number of messages exchanged to get the average latency. Time associated with the zero byte messages in FIG. 8 is the average time needed to evaluate Ccp-sequences, CcpSeq(P) at ports P. Coding was relatively straightforward and simple. We will not enter into details here. We will present some coding details for the next example discussed in the following subsection. It may be

TABLE III
PollPorts( ) of Latency Test cell, LT_Cell.

int LT_Cell::pollPorts( ) {

if (initialization) {

for (int i = 0; i < 2; i++) {
/*Prepares msg and writes it into write-memory. MSG_LEN,
a global variable, specifies the length of message. */

generalPorts[i]->prepareMsg(MSG_LEN);
//sends it off
generalPorts[i]->sendImmediate( );

}
initialization = false;

}
startTime = clock( );
/*N_MAX is the maximum number of messages*/
while (nOfMsgs < N_MAX) {

for (int i = 0; i < 2; i++) {

if (functionPorts[i]->messageReady( ) ) {

/*copies received msg and sends it off to configurator.
Constructs a response message and replies back to the sender. */

functionPorts[i]->respond(MSG_LEN);
functionPorts[i]->sendImmediate( ); }

}
for (int i = 0; i < 2; i++) {

if (generalPorts[i]->messageReady( ) ) {

/*copies received msg and sends it off to configurator.
Constructs a response message and replies back to
the sender. */
generalPorts[i]->respond(MSG_LEN);
generalPorts[i]->sendImmediate( );

}

nOfMsgs++;

}//end of while statement
prepareToTerminate( );
//informs configurator
interruptPort.sendImmediate( );
endTime = clock( );
return 0;

}

noted this Latency-Test program is not scalable, because the number of messages that may be exchanged at any given moment is limited by the rate at which Configurator could save messages. In order to make this scalable, each cell should be made to save its messages in its own separate output vector.

PollPorts( ) for latency test cell, LT_cell, is shown in Table III. It is self-explanatory. Cell_{—}0 and Cell_{—}1 in FIG. 8 are instances of LT_Cell. Configurator saves messages forwarded to it and acknowledges receipt. PollPorts( ) for the configurator is not shown here.

8.2. Parallel Non-Scalable FFT Benchmark (June 2005)

[image]

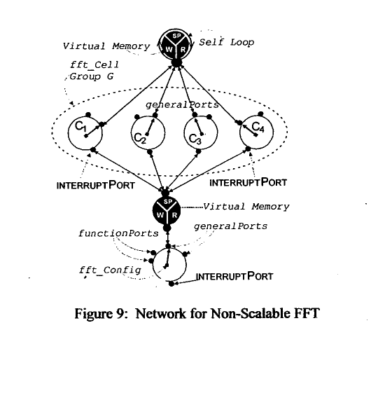

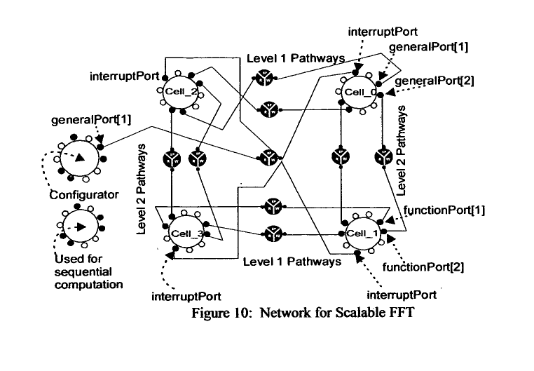

Two networks for the FFT test are shown in FIGS. 9 and 10. We used both these networks to perform complex double precision 1D FFT computations [36]. Each FFT computation had S sample point inputs, for 64≦S≦4096. For a given S, one thousand FFT computations were done in each run of FFT parallel program, each on a distinct set of S sample points. Maximum of the power spectra for each FFT computation was printed out at the end together with timing statistics. Our multiprocessor had only 4 CPUs. Therefore, we used only 4 cells in our FFT computations.

In each FFT computation the sample points were distributed equally among four cells. For S sample points, the FFT computation consisted of Log₂(S) levels. At level zero, each cell did its computation on its share of S/4 input sample points. Thereafter at each level, L, 1≦L<Log₂(S) each cell did its computations on results obtained at level (L-1) by itself and another cell as per rules of FFT computation (see [36]).

One may be notice in Table IV, for levels 1≦i<N/2 (where N is the number of processors), at the end of each level of computation, each cell sends a message through the self-loop using its generalPorts[1]. The agent on the self-loop will automatically synchronize messages sent by the four cells and make a synchronized message delivery back to the same four cells (Section 5.5). When the message is received, each cell will pick up its share of data in the message as per rules of data exchange in FFT [36]. This will start computations in the four cells at the next level at nearly the same time (at most 8 Nanoseconds of each other). Only Level-1 synchronization was used.

TABLE IV
PollPorts for non-Scalable FFT.

int FFT_Cell0::pollPorts( ) {

if (initialization) { installSeedCells( ); initialization = false; }
nOfCycles = 0;
startTime = clock( );
while (nOfCycles < N_OF_FFTS) {

/*level 0 computations. Takes inputs from sample points. */
doInputComputations( );
generalPorts[1]->sendImmediate( );
//level 1 ≦ L < N/2 computations
for (int i = 1; i < N/2; i++) {

generalPorts[1]->receive( );
doLoopComputations( );
generalPorts[1]->sendImmediate( );

}
/*Level N/2 computation. No Message is sent out. */
generalPorts[1]->receive( );
doLoopComputations( );
doSelfComputations( );
nOfCycles++;

}//end of while loop
/*msg is sent to synchronize the start of findAndSaveMaxPower( ); */
generalPorts[1]->sendImmediate( );
//receiving the synchronizing msg.
generalPorts[1]->receive( );
findAndSaveMaxPower( );
endTime = clock( );
/*Informing fft_config that computations are being terminated. */
interruptPort.sendImmediate( );
/*prepares to release the processor. prepareToRelease( ) is in API. */
prepareToTerminate( );
return 0;

}

Starting at level (N/2+1) through level (L-1) each cell will have in its local data array all needed data to continue with the rest of FFT computations. It is not thus necessary to send messages any more via the self-loop. Starting at level (N/2+1) through level (L-1) each cell will have in its local data array all needed data to continue with the rest of FFT computations. It is not thus necessary to send messages any more via the self-loop.

As the number of cells increases, synchronization delay and message delivery latency will also increase in the arrangement shown in FIG. 10. In addition, since there is only one virtualMemory, memory blocking will also increase. These two factors will limit scalability.

8.3. Parallel Scalable FFT Benchmark (June 2005)

FIG. 10 shows the network used for the scalable version of FFT. Here also increasing the number of cells would increase synchronization delay but, as we shall see, this synchronization is not done at every level of FFT computation. It is done only at the beginning of each new FFT computation on a new set of S sample points. Computations at successive levels of FFT computation need not be synchronized. They are automatically coordinated by messages exchanged by the cells at the end of each level. Since each cell sends out its message in parallel with other cells at each level of computation, message exchange latency will not increase. Since each cell at each level performs, its computation using a distinct local memory, memory blocking will not increase as number of cells increases. Thus, one may expect that the network in FIG. 10 would be scalable. Hence the name. Its actual scalability remains yet to be tested.

[image]

The network images in FIGS. 9 and 10 are copies of images produced by Ticc-Gui. Each network has a Configurator and four cells, cell_{—}0 through cell_{—}3. Each runs in its own assigned CPU. The two networks perform the same FFT computation using the same code except for different

TABLE V
PollPorts for the Scalable FFT

int FFT_Cell::pollPorts( ) {

/*InstallSeedCells( )does initialization /*
if (initialization) { installSeedCells( ); initialization = false; }
//clocks the beginning of computations
startTime = clock( );
//nOfCycles = current cycle number. Starts at 0.
N_OF_FFTS = 1000 nOfCycles = 0;
while (nOfcycles < N_OF_FFTS) {
/*Synchronization step: Receives acknowledgements from
N/2 cells.*/

for (unsigned int i≃1; i=<N/2; i++)generalPorts[i]->receive( );
/*Uses sample points from array of random numbers to do level
0 computation. Writes output into memory of pathway at
generalPorts[1]*/
doLevel0Computations( );
/* immediately sends result to level 1.*/
generalPorts [1]->sendImmediate( );
for (unsigned int i = 1; i < N/2; i++) {

/*Waits and receives level-i data at

functionPorts[i]*/

functionPorts[i]->receive( );
/*Does level i computations for 1≦i<N/2/*
doLoopComputations( );
/*Sends output to level i+1 immediately./*
generalPorts[i+1]->sendImmediate( );

}
/*Performs the last loop computation at level N/2. Does not
send out output to level (N/2 +1).*/
functionPorts[N/2]->receive( );
doLoopComputations( );
/*Each cell will henceforth have in its local data all information
needed to proceed with fft calculations at the remaining levels.
Self-computations begin at level (N/2 + 1) and end at level
(Log₂(S)−1)= L-1*/
doSelfComputatons( );
//sends back acknowledgements at end of level L-1
for (unsigned int i=1; i ≦ N/2; i++) {

functionPorts [i]->sendImmediate( );

}
nOfCycles++; //Increments the cycle number.

}//returns to while loop.
/* gets synchronized before starting to find max power./*
for (unsigned int i = 1; i =< N/2; i++) generalPorts[i]->receive( );
/*Finds max power of each spectra and saves it. */
findAndSaveMaxPower( );
//sends termination signal to configurator.
interruptPort.sendImmediate( );
endTime = clock( );
prepareToTerminate( );
return 0;

}

initializations and different pollPorts( ). Initializations and pollPorts( ) had to be different because the networks are different. They both produced identical results for identical input sample points, because they are essentially the same. With only four cells, they both produced also identical timings, speed-ups and efficiencies, as shown in Table VI. This is an example of the kind of flexibility we mentioned in Section 3.3 paragraph 0038 of SUMMARY.

TABLE VI
Timing Statistics for FFT
FFT_Scalable and FFT_Non-scalable Performance.
with four 2.2 GigaHertz/sec processors and 1000 runs
per FFT session.,

| | Parallel | Sequential | | |
|---|---|---|---|---|
| Sample | Time per | Time per | | |
| Size, S, | FFT Micro | FFT Micro | Speed | |
| per FFT | Secs | Secs | Up | Efficiency |
| 4096 | 1610 | 13040 | 8.10 | 220.50% |
| 2048 | 750 | 3320 | 4.43 | 110.75% |
| 1024 | 320 | 780 | 2.44 | 61.00% |
| 512 | 180 | 300 | 1.67 | 41.28% |
| 256 | 90 | 110 | 1.22 | 30.50% |
| 128 | 50 | 60 | 1.20 | 30.00% |
| 64 | 30 | 30 | 1.00 | 25% |

Comments: All computations in Latency-Test program were asynchronous and all computations in FFT programs were synchronous. This is because FFT calculation required coordination or synchronization at each level. All coordination and synchronization were completely automatic. User did not have to do anything to invoke coordination of synchronization. In the non-scalable version, messages were exchange by cell-groups and in the scalable version, messages were exchanged individually by each cell, in parallel with other cells. As number of cells is increased the size of the FFT problem, S, will also increase since grain size, S/N should remain the same throughout.

### 9. CONCLUDING REMARKS

We introduced two new concepts, (i) a new model of parallel programming and (ii) integrated computation and communication. These two concepts naturally gave rise to the architecture of Ticc and Ticc-Ppde that we described here. Ticc-Ppde provides the environment and methods to use Ticc for parallel program development and execution. We discussed the benefits that ensue and new capabilities that they provide. The most important of these are (i) ease of parallel program development and maintenance, (ii) high execution efficiencies and (iii) potential for scalability.

We believe Ticc-Ppde may profoundly change the technology of parallel programming, making parallel programming as ubiquitous as sequential programming is today, dramatically increasing supercomputer throughputs through increased efficiencies of operation, thereby enabling high performance computing by less expensive desk-top multiprocessors. A 32-machine shared memory multiprocessor running Ticc-Ppde can easily outperform a 128-machine cluster.

Opportunities offered by Ticc-Ppde for ease of programming, dynamic debugging and updating, and potentially unlimited scalability makes Ticc an attractive choice to meet future challenges we will face with massive parallelism when nano-scale computing becomes a reality. Ticc is also likely to change the structure and organization of future multiprocessors and supercomputers, and design of operating systems.

### 8. REFERENCES

Please see section on Application Data.

What is claimed is:

1: In a Parallel Program Development and Execution platform using Technology for Integrated Computation and Communication (Ticc-Ppde), for writing parallel programs to perform intended computations for an application, hereinafter called The Application System, consisting of programs that run in multiprocessing computer systems with two or more processors, hereinafter referred to as The Multiprocessor, The Application System composed of software classes called Cell, Port, VirtualMemory, Agent and Message, instances of software classes being software objects referred to as cells, ports, virtualMemory, agents and messages, respectively, installed by The Application System running in The Multiprocessor, each cell containing an arbitrary number of ports attached to said cell, attachment enabling said cell and cell ports to exchange private data with each other, ports of different cells interconnected by pathways, each pathway containing one virtualMemory and an arbitrary number of agents, the collection of all such cells, ports, agents, virtualMemories and pathways being called the Ticc-Application Network of The Application System, hereinafter referred to as The Network, each Cell, Port, Agent, VirtualMemory and Message class in The Application System containing application dependent software data structures and programs, each cell in The Network being capable of performing computations in parallel with all other cells in The Network by exchanging messages with other cells in The Network in parallel with other cells via pathways connected to ports of said cells, without using assistance of the operating system that runs The Multiprocessor, using Technology for Integrated Computation and Communication (Ticc), each said cell running in a processor of The Multiprocessor, The method comprising of following steps
for installing and modifying cells, ports, agents, virtualMemories and pathways in The Network;
for allocating real memories to virtualMemories in The Network from memory areas of a hardware memory units shared by all processors in a Shared Memory Multiprocessor;
for allocating real memories to virtualMemories in The Network from memory areas of a collection of distributed hardware memory units, where each distributed hardware memory unit is shared by a processor-group containing a limited number of processors, each processor in said processor-group being assigned to run a unique cell in The Network, thereby forming a corresponding cell-group consisting only of cells that are run by processors in the said processor-group, cells in each said cell-group being capable of writing into virtual memories of pathways attached to ports of a limited number of neighboring cell-groups run by processors in other processor-groups, these other processor-groups being neighbors of the said processor-group;
for allocating virtual memories to pathways in a manner that minimize memory blocking and memory contention and thus contribute to scalability;
for automatically dynamically allocating a processor to each cell in The Network so that cells in each cell-group are allocated to processors in one and the same processor-group;
for dynamically installing new cells and new pathways in The Network, dynamically modifying existing pathways and cells, without service interruption and without loss of data, while the multiprocessing system is running said parallel programs; and
for developing dynamic self-diagnosis and self-repair facilities for The Application System.

2: Method as recited in claim 1 further including steps for organizing and running parallel programs in The Application System defined by a collection of sequential processes, there being greater than one such said sequential process, each said sequential process running in parallel with other sequential processes and all sequential processes together performing the intended parallel computation of The Application System by employing the following additional steps,
for cutting up each sequential process into a collection of threads;
for distributing said threads among ports in The Network at the rate of one or more threads per said ports, thread assigned to a port being called a thread of said port, there being pairs of ports belonging to a cell being mutually independent in the sense that no port in any pair in the said pairs of ports would use data generated by the other port belonging to said pair, at any time no more than one thread of a port of a cell in The Network being active performing computations, said thread being called the Active Thread of said cell, threads assigned to ports attached to a cell being activated one after the other by arrival of new messages at said ports, Active Threads of different cells in The Network performing computations in parallel and exchanging messages in parallel, parallel computations terminating when all computations performed by all threads associated will all ports in The Network terminate their respective computations and no thread is activated again, causing The Application System to perform precisely the intended computation of The Application System;
for suspending and resuming computations performed by said threads without loss of data and without invoking assistance from the operating system that runs The Multiprocessor;
for automatic asynchronous message driven thread activation, activating thread belonging to a port of a cell when a message is received by said cell at said port, once activated allowing the thread to complete its computations even if such computations were suspended in the middle and later resumed, said computations being always the computations necessary to respond to said received message;
for enabling each Active Thread to send message by itself using pathway attached to the port of said thread and using Ticc, in parallel with other Active Threads in The Application System without message interference and without invoking assistance from the operating system that runs The Multiprocessor;
for guaranteeing high-speed parallel message delivery without message interference, the number of such messages sent at any time being limited only by the number of cells in The Network, thereby facilitating scalability;
for automatic asynchronous message driven scheduling and activation of threads in such a manner that control flow of computations in The Network is always isomorphic to message flow, enabling parallel program development with no need to specify methods for process scheduling, process activation, process synchronization and process coordination;
for selection of different level numbers from available pool of level numbers for specifying level of synchronization at each point of data distribution in The Network and coordination at each port of thread activation, increasing level numbers specifying increasing precision in timings of said synchronization and coordination, levels of said synchronization and coordination being chosen by The Application System programmer; and
for automatic enforcement of application system security and privilege specifications at the time of message delivery, at the time of cell or pathway installation and at the time of dynamic reconfiguration of The Network.

3: Method as recited in claim 1 or 2 further including steps,
for starting and stopping parallel programs;
for specifying parallel breakpoints in pathways in The Network using Ticc to temporarily suspend parallel computations in cells whose ports are connected to said pathways and examine data in virtual memories of said pathways, in order to dynamically debug a parallel program;
for dynamically testing new versions of cells in The Network using Ticc, in parallel with old versions, in the same network context in which the old version operates using Ticc, and after satisfactorily completing the test replacing the old version with the new version, without interfering with ongoing computations, thus enabling dynamic evolution of The Application System;
for encapsulating any well-defined networks, consisting of cells with attached ports and pathways with agents and virtual memories interconnecting said ports, in to a Software Component, which can be plugged into a larger network containing matching port interfaces, in a manner similar to the way a hardware module may be plugged into a larger hardware system using matching plug-in connections;
for building a library of such components, said components being downloaded from said library and used to build new parallel programs,
for dynamically displaying parallel outputs while The Application System is running, without interfering with ongoing operations; and
for simplifying parallel program development through use of pathway abstraction, enabling programs for each cell in The Network to be separated out into two distinct non-overlapping units, one unit being the Thread Definition unit, the said Thread Definition unit consisting of specifications of sequential computations performed by threads associated with ports of each cell in The Network, said sequential computations being specified in any sequential programming language, the other unit being the Thread Execution unit, the said Thread Execution unit consisting of specifications of parallel interactions and parallel communications among threads associated with ports of each cell in The Network when said threads are performing their respective sequential computations, said parallel interactions and parallel communications being specified using command statements in the Application Programmer Interface (API) provided by Ticc-Ppde, it being possible to use the same Thread Definition unit with different Thread Execution units to find and select one that optimizes performance of The Application System.
